(19) United States
(12) Patent Application Publication
(10) Pub. No.: US 2023/0006760 A1
(43) Pub. Date: Jan. 5, 2023

(54) METHOD AND APPARATUS FOR OPTICAL PULSE SEQUENCE GENERATION

(71) Applicant: UNIVERSITY OF SOUTHAMPTON, Southampton (US)

(72) Inventors: Ke LI, Southampton (GB); David John THOMSON, Southampton, (GB); Shenghao LIU, Southampton, (GB); Graham Trevor REED, Southampton, (GB); Weiwei ZHANG, Southampton, (GB); Wei CAO, Southampton, (GB)

(21) Appl. No.: 17/756,592

(22) PCT Filed: Nov. 26, 2020
(86) PCT No.: PCT/GB2020/053001

§ 371 Date: May 27, 2022

(30) Foreign Application Priority Data
Nov. 27, 2019 (GB) 1917289.9

(51) Int. Cl. H04J 14/08; H04Q 11/00

(52) U.S. Cl. CPC H04J 14/08; H04Q 11/0005; G02F 1/212

(57) ABSTRACT

A method of generating multiple channels of optical pulses comprises: providing a continuous wave optical input having an optical power; dividing the optical power of the optical input into equal consecutive slices in the time domain; and allocating the consecutive slices sequentially to two or more optical outputs such that each output forms a channel of optical pulses of equal pulse repetition rate shifted in time relative to the or each other channel.

### BACKGROUND OF THE INVENTION

The present invention relates to a method and apparatus for optical pulse sequence generation.

Time division multiplexing (TDM) is a well-known technique for transmitting data in which multiple data-carrying channels are multiplexed into a single signal for transmission by allocating successive time portions of the signal to the various channels in a repeating sequence. The signal amplitude of the time portions of each channel is modulated to encode or indicate the data carried by that channel. Each channel hence carries data at a particular speed or bit rate which is lower than the combined bit rate for the multiplexed signal, which can be up to the maximum bit rate able to be handled by the medium used for transmission.

An example of TDM, commonly used in modern telecommunications, is optical time division multiplexing (OTDM), in which light is transmitted to carry the data in each channel. Each channel comprises a series of pulses of optical power at the same, specified, repetition rate, and the pulses in each channel are offset or delayed in time relative to the pulses in the other channels to form an interleaved sequence of pulses, being the multiplexed signal, when the channels are combined. Typically, optical (photonic) components and electronic components are used in combination in order to generate the optical pulses and modulate the pulse amplitudes to encode the data onto each channel. This allows the components to operate at a lower speed (which is typically more practical and achievable) than the total speed of the multiplexed signal able to be supported by the optical fibre transmission medium. The components can be miniaturised chip-based components, in which the light is carried by optical waveguides formed in the chip material.

Many known OTDM devices create the pulse sequences for each channel by introducing different amounts of optical delay to synchronised pulse sequences initially lacking the required offset in time. The delays shift the pulses to the required time positions to create the interleaving in the multiplexed signal. The delay is applied using optical delay lines in the form of different lengths of optical fibre or on-chip waveguide for each channel, so that the different pulse sequences experience different propagation times through the delay lines and hence emerge with offset pulse timings.

This approach has drawbacks, however. Firstly, the optical delay lines inevitably introduce optical insertion loss for each channel, whereby optical power is lost in the mere process of propagation along the delay line. This is undesirable in itself, but made worse by the longer delays lines producing greater overall loss so the different channels are degraded by different amounts. Secondly, the amount of delay, and hence the rate of pulses in the multiplexed signal, is determined by the fixed physical lengths of the delay lines, so that a given OTDM device can operate at a single speed or bit rate (data rate) only. This may limit the practical utilisation of the device, and offers no data rate flexibility.

Accordingly, improved optical pulse sequence generation methods and apparatus for optical pulse sequence generation are of interest.

### SUMMARY OF THE INVENTION

Aspects and embodiments are set out in the appended claims.

According to a first aspect of certain embodiments described herein, there is provided a method of generating multiple channels of optical pulses, comprising: providing a continuous wave optical input having an optical power; dividing the optical power of the optical input into equal consecutive slices in the time domain; and allocating the consecutive slices sequentially to two or more optical outputs such that each output forms a channel of optical pulses of equal pulse repetition rate shifted in time relative to the or each other channel.

According to a second aspect of certain embodiments described herein, there is provided a device for generating multiple channels of optical pulses, the device comprising: an electro-optic modulator configured to receive an input comprising a continuous wave optical input having an optical power; a signal generator configured to generate drive signals for the electro-optic modulator comprising a first pair of oscillating voltages with a phase difference of 180°; and an optical combiner configured to receive the modulated optical power from the electro-optic modulator and pass alternate portions of the optical power to two output ports; in order to divide the optical power of the optical input into equal consecutive slices in the time domain, and allocate the consecutive slices sequentially to the two output ports such that the output from each output port forms a channel of optical pulses of equal pulse repetition rate shifted in time relative to the other channel.

These and further aspects of certain embodiments are set out in the appended independent and dependent claims. It will be appreciated that features of the dependent claims may be combined with each other and features of the independent claims in combinations other than those explicitly set out in the claims. Furthermore, the approach described herein is not restricted to specific embodiments such as set out below, but includes and contemplates any appropriate combinations of features presented herein. For example, methods and apparatus may be provided in accordance with approaches described herein which includes any one or more of the various features described below as appropriate.

### BRIEF DESCRIPTION OF THE DRAWINGS

For a better understanding of the invention and to show how the same may be carried into effect reference is now made by way of example to the accompanying drawings in which:

FIG. 1 shows a schematic representation of a previously proposed example of a known optical time division multiplexing (OTDM) system [1];

FIG. 2 shows a schematic representation of another previously proposed example OTDM system [2];

FIG. 3 shows a graph of power against time for a quantity of optical pulses produced according to a pulse generation method disclosed herein;

FIG. 4 shows a graph of power against time showing the allocation of optical power to multiple channels in the system of FIG. 2;

FIG. 5 shows a schematic representation of a first example pulse generation apparatus according to the present disclosure, configured to generate two channels of optical pulses;

FIG. 6 shows a graph of power against time in a computer simulation of a multiplexed signal comprising two channels generated using apparatus of the type shown in FIG. 5;

FIG. 7 shows a schematic representation of a second example pulse generation apparatus according to the present disclosure, configured to generate four channels of optical pulses;

FIG. 8A shows a graph of power against time in a computer simulation of differential optical pulses produced at an intermediate location in the apparatus of the type shown in FIG. 7;

FIG. 8B shows a graph of power against time in a computer simulation of quadrature optical pulses generated using apparatus of the type shown in FIG. 7;

FIG. 9 shows a schematic representation of a first example of apparatus configured to perform OTDM based on pulse generation as described herein;

FIG. 10 shows a schematic representation of a second example of apparatus configured to perform OTDM based on pulse generation as described herein;

FIGS. 11A, 11B and 11C shows results of computer simulations of the operation of the example OTDM devices of FIGS. 9 and 10, in the form of eye diagrams;

FIG. 12 shows a simplified schematic representation of an example of a segmented electro-optic modulator configured to modulate optical pulses generated according to methods disclosed herein;

FIG. 13 shows results of computer simulations of PAM-N modulation schemes performed using segmented modulators of the type shown in FIG. 12 operating on pulses generated by apparatus of the type shown in FIGS. 9 and 10;

FIG. 14 shows a schematic representation of a first example of apparatus configured to perform analogue-to-digital conversion based on pulse generation as described herein;

FIG. 15 shows a schematic representation of a second example of apparatus configured to perform analogue-to-digital conversion based on pulse generation as described herein;

FIG. 16 shows a schematic representation of experimental apparatus configured to implement generation of differential optical pulses according to methods proposed herein;

FIG. 17 shows a schematic representation of experimental apparatus configured to implement generation of quadrature optical pulses according to methods proposed herein;

FIG. 18 shows a schematic representation of experimental apparatus configured to implement modulation of differential optical pulses according to methods proposed herein;

FIG. 19 shows a flow chart of steps in an example method of optical pulse generation proposed herein;

FIG. 20 shows a schematic block diagram of an optical multiplexer-demultiplexer utilising OTDM and pulse generation as described herein; and

FIG. 21 shows a schematic representation of an example demultiplexer suitable for demultiplexing a signal of multiplexed optical pulses generated using OTDM as described herein.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

FIG. 1 shows a schematic representation of a previously proposed example of a known optical time division multiplexing (OTDM) system [1]. An optical source 1, such as a mode-locked laser, is configured to generate a pulsed optical input 2 for the system, comprising a stream of optical pulses 3 with a pulse width and a pulse repetition rate. For a desired symbol rate fs in the final multiplexed output, the repetition rate is fs/4 (where this system operates over four channels), and the pulse width Ts, or symbol period, corresponds to the inverse of the symbol rate, so Ts=1/fs. The input 2 enters the system at an input coupler 4 which couples the light into a waveguide network to carry the light through the system, which is chip-based. The light enters the input port of a first 1×2 splitter 5 which divides the light equally between two output ports. Each output port passes the light to two further 1×2 splitters 6 which again divide the light equally, producing four channels 7 each carrying a quarter of the power of the original optical input, and comprising a pulse sequence of the original repetition rate fs/4 synchronised in time with the pulse sequences of the other channels (so that the pulses overlap in the time domain). A waveguide carries each channel 7 through an electro-optic modulator 8, each of which is driven by an appropriate driving signal 9 representing an electrical input 10 desired to be encoded onto each channel. The modulators 8 modulate the power amplitude of the pulses in each channel 7 according to the electrical inputs 10. For example, the electrical inputs 10 may be configured to encode data according to a known scheme, such as OOK or PAM-4.

The modulators 8 each output the modulated pulses sequences into a waveguide having an optical delay line 11 comprising one or more spiral waveguide portions 12, which act to increase the length of the respective waveguides and hence increase the propagation time for light in each channel. Recalling that the symbol period is Ts, each optical delay line 11 introduces a delay which is a multiple of the symbol period in order to offset the pulses between the channels by an appropriate amount to achieve the symbol rate fs. Hence, a first channel has no delay line so provide a zero delay, OTs, a second channel has a delay line that delays by Ts, a third channel delays by 2 Ts and the fourth channel delays by 3 Ts. In this example each spiral waveguide portion 12 is designed to delay by Ts, and each channel has a number of spiral waveguide portions 12 that gives the desired total delay. Hence, the output 13 from the delay lines 11 is the four pulse sequences each delayed relative to the original sequence timing by a multiple of Ts. In order to achieve the final multiplexed and modulated signal, the four channels are coupled into the input ports of two 2×1 optical combiners 14, the two output ports of which are fed to the input ports of a final 2×1 combiner 15, the output of which is delivered to an output coupler 16. The output coupler 16 outputs the multiplexed signal 17, which comprises the four channels combined, in which the relative delays of the channels mean that the pulses of the four channels are interleaved in a repeating sequence.

In the published report of this known example [1], data rates of 104 Gbaud and 208 Gbaud were reported for OOK and PAM-4 coding respectively. The electronic components, namely the modulators 8, operated at the much lower speed of 26 Gbaud (note this is one quarter of the OOK speed). This corresponds to a symbol period Ts of 9.6 ps. Hence, each spiral waveguide 12 provides this amount of delay, giving overall a 9.6 ps difference between adjacent channels. While this data rate is usefully high, it is also fixed at a given wavelength, according to the length of the spiral waveguides, and cannot be changed within a given system. Also, inevitable fabrication variations between systems intended to be identical will change the intended fixed rate slightly, giving inconsistencies.

This is problematic in the context of telecommunications, in which IEEE standards strictly define data rates that must be used. There is no tolerance for data rates within a range, since the applicable rate for any system defines a large number of operating parameters such as data-frame rate, clock speed and synchronisation. Accordingly, an OTDM device that does not comply with the standards will not be accepted for use in the telecommunications industry.

Also, there is an amplitude difference between successive bits in the multiplexed signal generated by the FIG. 1 arrangement, owing to the different levels of insertion loss introduced by the different lengths of delay line. This quality difference in optical modulation amplitude is also undesirable in a commercial arrangement.

Hence, it can be seen that the use of optical delay lines in an OTDM device has associated drawbacks.

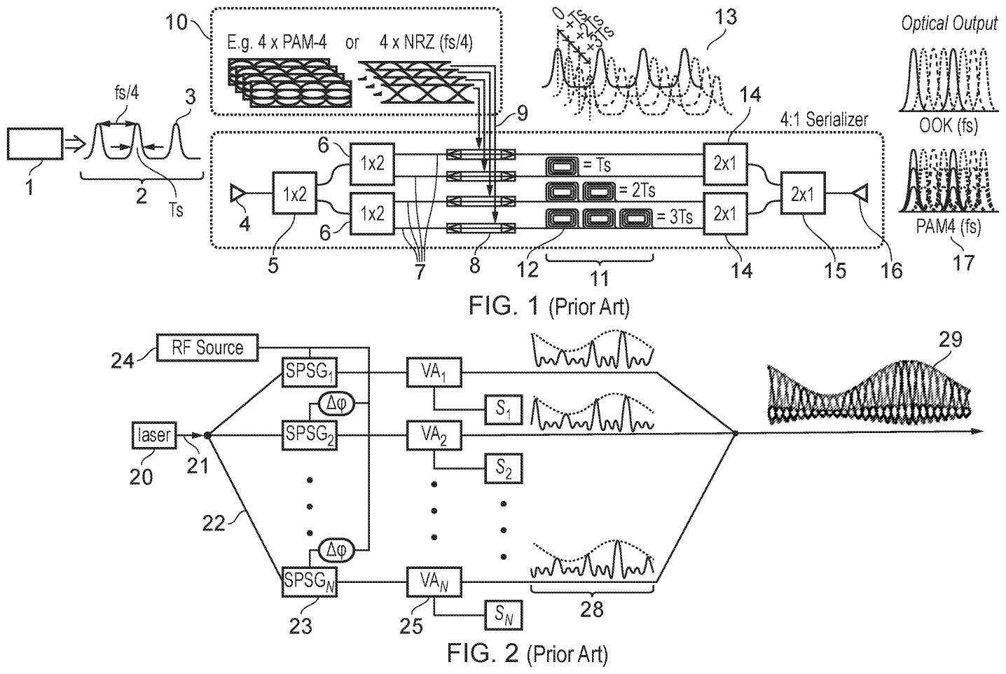

FIG. 2 shows a schematic representation of a further previously proposed example OTDM system which achieves a multiplexed signal without optical delay lines [2].

In this system, an optical source 20 in the form of a laser is configured to produce a continuous wave optical input 21 for the system. Note the contrast with the pulsed optical input of the FIG. 1 arrangement, where the pulses required for OTDM are present in the input stage. The FIG. 2 system uses a non-pulsed, continuous wave optical signal as its input, and creates the pulses at a later stage. The continuous wave laser beam 21 is passed through an optical splitter arrangement 22 which divides the light equally between multiple branches or channels, so that each branch carries the same level of continuous wave power. Each branch 22 delivers its light to a so-called “sinc-pulse sequence generator” 23. These are described in detail elsewhere [3], but comprise electro-optic intensity modulators driven by n radio frequencies (RF) from an RF source 24 which output a sequence of pulses in the form of Nyquist-shaped sinc pulses. For the present purposes, the form of the pulses is not important. However, in the FIG. 2 system, each pulse generator 23 is driven at a different phase delay Δφ of the RF drive signals. This has the effect of delaying the pulse sequences in time relative to each other, in proportion to the size of the phase delay. Hence, the pulses generators 23 output the desired multiple channels of pulse sequences with different time delays, required for OTDM. The different channels are then each delivered to a variable attenuator 25, each of which is driven by an electrical signal S1, S2 . . . SN corresponding to the data to be modulated onto each channel. The variable attenuators 25 therefore output the channels of pulse sequences 28 each appropriately modulated in amplitude. The channels are combined to achieve an interleaved, multiplexed signal 29, and coupled out of the system.

The FIG. 2 arrangement therefore achieves OTDM without the use of optical delay lines, thereby addressing some of the issues with the FIG. 1 arrangement. However, a common feature of both arrangements is that the initial optical input to the OTDM device is divided between the multiple channels by splitting the power equally, so the optical power in each channel is a portion of the original optical input power from the optical source or laser. Each channel thus carries a lower amplitude version of the original input sequence, in which pulses are already present in the case of FIG. 1, or in which pulses are formed in the case of FIG. 2. Recalling that the systems are configured to write data onto the channels by amplitude modulation, the available modulation depth within each channel is therefore limited, owing to the reduced power amplitude per channel.

The present disclosure proposes to address this drawback by taking the total optical power originating from the optical source and dividing it by splitting it into consecutive portions or slices in the time domain, rather than in the power domain. Each slice has the same finite duration, so that all slices are substantially equal in time. For a continuous wave optical power input, a sequence of consecutive and contiguous slices of power with respect to time is hence achieved, where each slice has the same power amplitude, which is, importantly, the same as the power amplitude of the original optical input. Then, the slices can be allocated in a repeating sequence across the desired number of channels, in order to define the required channels, each slice becoming a pulse. Each channel comprises a sequence of pulses of the original power amplitude and having the same repetition rate (according to the equal duration of the slices and the number of channels to which the slices are allocated), but each sequence being shifted in time relative to the other channel sequences since each slice occupies a unique portion of time. The pulses of each channel can be separated out from those of the other channels in order to be utilised as required. For example, to achieve OTDM as described above, the pulses of each channel undergo amplitude modulation to receive the data to be carried by that channel, and the individual pulse sequences are then recombined to provide a multiplexed signal. This is an example of digital to analogue conversion (DAC), where digital data is carried by electrical drive signals for modulators used to perform the amplitude modulation, and hence converted into analogue data represented by the pulse amplitudes.

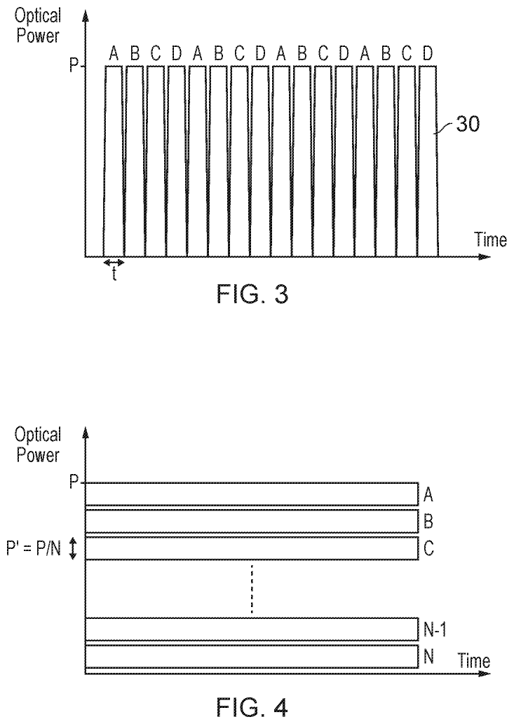

FIG. 3 shows a graph of power against time for a quantity of pulses 30 produced in this manner. A continuous wave of optical power P is provided. The term “continuous wave” indicates that power is continuously present at all times, in contrast with a pulsed wave or signal, in which brief bursts of power are interspersed with periods of zero power, typically at a fixed frequency or pulse repetition rate. In some cases, the power of a continuous wave may have a varying non-zero value over time, but in the present case, the power P is usefully maintained constant so that all pulses generated by slicing the power in the time domain have the same power amplitude, to which amplitude modulation can be applied. The continuous power P has been sliced into equal portions in the time domain, each of the same duration t, where each interval t is contiguous with the preceding and following intervals. Then, the series of contiguous pulses obtained by the slicing is allocated in sequence to the required channels, which in this case comprise a total of 4 channels, A, B, C and D. Hence, a first pulse and every following fourth pulse is allocated to channel A, a second pulse and every following fourth pulse is allocated to channel B, a third pulse and every following fourth pulse is allocated to channel C, and a fourth pulse and every following fourth is allocated to channel D. The next, fifth, pulse already belongs to channel A. The pulses may be separated out of the contiguous sequence for each channel for processing such as by amplitude modulation, and recombined into a multiplexed signal later if appropriate, in which case they will have the same interleaved sequence in time as shown in FIG. 2. Of course, more than four or fewer than four channels could be created if desired, by suitable repetitive sequential distribution of consecutive pulses. Apparatus to generate the pulse sequences may be configured accordingly.

FIG. 4 shows a graph of power against time showing the allocation of power to multiple channels in the known system of FIG. 2. Again, a continuous wave of constant power P is provided, but it is divided in the power domain into equal portions, to provide multiple portions A to N each with a lower power P′ equal to P/N, which gives a power which is constant over time for each channel. These portions of constant power are then delivered to the pulse generators shown in FIG. 2 to be converted into pulse sequences. The same approach is effectively used in the FIG. 1 system, although the input power is already in a pulsed format, of peak pulse power P. Each of the four channels ends up with a lower peak pulse power of P/4.

In reality, pulses produced according to the proposed time-slicing scheme will have slightly lower power or intensity than the original continuous wave input, but this is due to unavoidable optical loss inherent in the components used to generate the pulses. Such loss is common to the approaches of FIGS. 1 and 2 also (so the pulse power will typically be slightly less than P′) so the proposed approach is not detrimental in this respect.

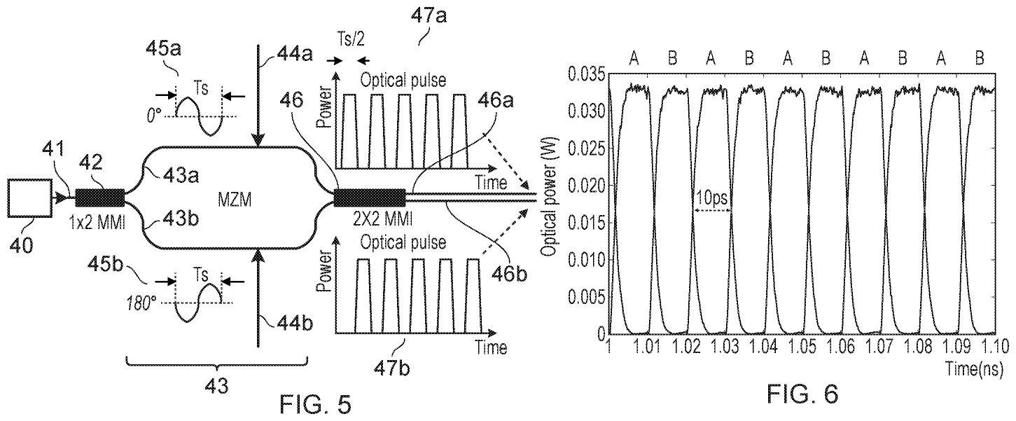

FIG. 5 shows a schematic representation of a first example apparatus or device configured to generate multiple channels of optical pulses, in this case, two channels. An optical source 40 generates a continuous wave (CW) optical signal 41 which is used as the optical input to the apparatus. The CW input enters an optical power splitter 42 which in this example comprises a 1×2 multimode interference (MMI) structure or device 42. Hence, the MMI device 42 has a single input port and two output ports and operates to distribute the CW optical power received at the input port equally between the two output ports. The two output ports pass the CW power into two arms of a Mach-Zehnder modulator (MZM) 43, being a Mach-Zehnder interferometer configured to modulate an optical signal passed therethrough in the known manner, namely by the application of electrical drive signals to electrodes (not shown) acting on each arm of the MZM to differently modulate the phase of light propagating in that arm.

A first arm 43a of the MZM 43 receives an electrical drive signal 44a in the form of a clock signal 45a (that is, a signal comprising an oscillating voltage) with a period Ts, and a phase that we can designate as 0° for the purposes of explanation. The second arm 43b of the MZM 43 receives an electrical drive signal 44b in the form of a clock signal 45a which again has a period Ts, in other words, the same period as the first clock signal 45a. However, the second clock signal 45b is arranged to be in antiphase with the first clock signal 45a, in other words, it has a phase of 180°. A pair of equal and opposite clock signals such as these can be termed differential clock signals. The voltage of the clock signals is set so that the peak-to-peak differential voltage between the two arms, V_{ppd}, is substantially equal to the half wave voltage (Vπ) of the MZM 43.

The outputs of the two arms 43a, 43b of the MZM 43 are coupled into the two input ports of a 2×2 MMI device 46. The action of the 2×2 MMI 46 (described further below) is to pass all the light from both input ports to one or other of its output ports depending on the phase of the light in one input port relative to the light in the other input port. Hence, if this relative phase, or the phase difference, between the input ports can be suitably arranged, the total light in both input ports can be alternately switched between the two output ports. Overall, therefore, the total CW power level entering the 1×2 MMI 42, which is split equally between the two arms of the MZM 43, can be recombined on an alternating and equal time basis at its original level between the two 2×2 MMI outputs 46a, 46b.

Hence, two output signals 47a, 47b are obtained which each comprise a sequence of pulses, corresponding to time slices from the original CW input, and each having the same power as the original CW power. However, the sequences are offset in time from one another (arising from the alternation of power at each output port 46a, 46b); the time during which a pulse is present in one sequence corresponds to zero power (no pulse) in the other sequence. The sequences 47a, 47b are therefore differential, in common with the two clock signals 44a, 44b. Each pulse in each sequence has a duration or pulse width of Ts/2, in other words, half the clock signal period Ts. This distribution of power between the two signals 47a, 47b makes ideal pulse sequences for OTDM; when combined, the pulses of the signals 47a, 47b will neatly interleave in the proposed manner shown in FIG. 3, to create a multiplexed signal. Each signal 47a, 47b can therefore be used as an OTDM channel, by being amplitude modulated.

FIG. 6 shows a computer simulation of such a multiplexed signal comprising two channels generated using apparatus of the type shown in FIG. 5. The results of the simulation are represented as a graph of optical power against time, with both channels plotted. The differential clock signals for driving the MZM had a frequency of 50 GHz, producing a pulse width Ts/2 of about 10 ps. As can be appreciated, all pulses have substantially equal width, spacing (repetition rate) and amplitude. However, alternate pulses belong to different channels, A and B.

Hence, the original optical input power can be substantially preserved in the output pulses, maximising the available range for amplitude modulation. Additionally, the proposed arrangement allows flexibility and tunability. If the clock signals for the MZM are generated from a tunable arrangement, their frequency can be altered as desired, which in turn alters the pulse duration of the channel pulses. Hence, bit rate flexibility is available.

In this regard, limitations may arise between the electrical and optical bandwidths of the MZM, but suitable design of amplifiers for the electrical drive signals and of the modulator electrodes can provide matching over at least a narrow frequency range such as over about 10 GHz (such as 45 GHz to 55 GHz), offering some tunability. Resonant enhancement techniques such as inductor peaking and microwave stubs could be used to implement this.

In the FIG. 5 example apparatus, and also in other examples described below, MMI structures are structures which are used to provide the functions of optical power splitting and combining. To describe the operation of these structures in more detail, a 2×2 MMI consists of two input single-mode waveguides followed by a multimode waveguide followed by two output single-mode waveguides. From the input single-mode waveguides and the multimode waveguide higher order modes are excited and propagate along the multimode waveguide, where interference then occurs between all the excited modes from the two ports. At certain lengths along the multimode waveguide this interference results in the self-imaging of the input light to two spots and the two single-mode output waveguides are positioned to coincide with the position of these spots. Assuming equal input power from the two input single-mode waveguides, the ratio of the total power to each of these spots (and therefore to the two output waveguides) is dependent on the relative phase of the light from the two input single-mode waveguides. A phase advance of π/2 to one of the input waveguides will result in all of the power exiting from one of the two output waveguides and a phase advance of π/2 to other input waveguide will result in all of the power exiting from the other output waveguide. The device therefore routes light to the two output waveguides depending on the relative phase of the light in the two input waveguides. In the presently proposed pulse generation scheme, utilising appropriate clock signals to drive a modulator that inputs to the MMI, the result is to allocate alternating portions of the input optical power received by the pulse generator between the two outputs, thereby dividing the input power into slices distributed sequentially to the two outputs. The MMI is just one example of a structure that can perform this function; other structures providing the same functionality may be used in place of MMIs in any of the disclosed examples. For example, directional couplers are also suitable.

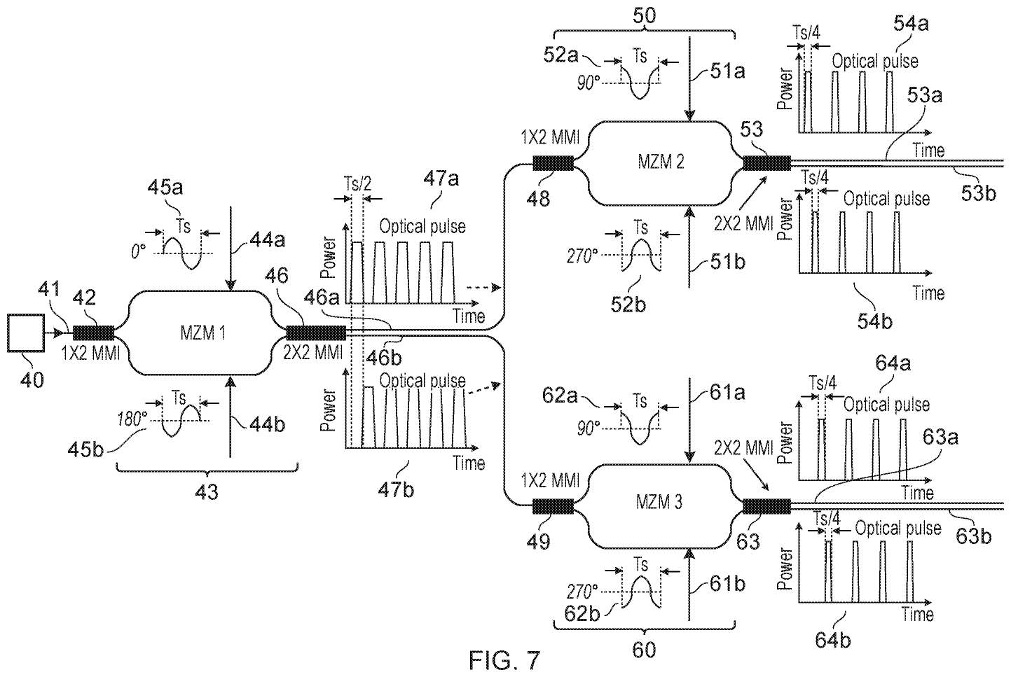

FIG. 7 shows a schematic representation of a second example apparatus configured to generate multiple channels of optical pulses. In this case, the two-channel configuration proposed in the FIG. 5 example is extended to generate four channels of interleaved pulses. The apparatus comprises a first part which is identical to the apparatus of FIG. 5, and hence produces the two differential pulse signals 47a, 47b, carried respectively by the two outputs 46a, 46b of the 2×2 MMI 46, and having pulse durations of Ts/2, derived from the clock pulses 45a, 45b used to drive the MZM 43, which can now be designated as a first MZM, (MZM1), since further MZMs are now included.

In order to extend the apparatus for four channels, each of the two differential pulses signals 47a, 47b is delivered to a further MZM arrangement. The first differential signal 47a is delivered by coupling the first output 46a of the 2×2 MMI 46 to the input of a first further 1×2 MMI 48, which splits the optical power of the signal 47a substantially equally between two arms of a second MZM 50 (MZM2). The two arms of the second MZM 50 are respectively driven by electrical drive signals 51a, 51b. The drive signals are, as before, clock signals 52a, 52b which have the same period Ts as for the first MZM 43. Again, the two clock signals 52a, 52b are differential, in other words, have a phase difference of 180°. However, the phase of each clock signal 52a, 52b is set with reference to the phase of the clock signals 45a, 45b of the first MZM 43, so as be in quadrature phase. Hence, one clock signal 52a for the second MZM 50 has a phase of 90°, and the other clock signal 52b for the second MZM 50 has a phase of 270°.

The two arms of the second MZM 50 are coupled to the two input ports of a first further 2×2 MMI 53. This operates as before to alternate the total power entering the second MZM 50 between its two outputs 53a, 53b, owing to the differential phase relationship of the clock signals 52a, 52b. Hence, the power of each pulse in the input signal 47a entering the second MZM is divided in half in the time domain, to provide one pulse to the first output 53a and one pulse to the second output 53b, each having a pulse duration of Ts/4, in other words, half the pulse duration Ts/2 of the original input to the second MZM 50. Hence, the result is two pulse sequences 54a, 54b each comprising pulses of equal power to the original CW input power from the optical source 40, of duration Ts/4, and separated by 3 Ts/4 (made up of the Ts/4 duration of the corresponding pulse in the other sequence and the space between pulses Ts/2 in the input pulse sequence 47a). The pulses in the sequence 54b lag the pulses in the sequence 54a by the same duration Ts/4, so are contiguous in time thereto.

This arrangement is repeated for the second differential signal 47b from the first MZM 43. Hence, the second output 46b of the 2×2 MMI 46 is coupled to the input of a second further 1×2 MMI 49 which splits the optical power of the signal 47b substantially equally between two arms of a third MZM 60 (MZM3). The two arms of the third MZM 60 are respectively driven by electrical drive signals 61a, 61b in the form of clock signals 62a, 62b which match the clock signals 52a, 52b used to drive the second MZM 50. Hence, the clock signals 62a, 62b have the same period Ts, are differential, and respectively at 90° and 270° phase compared to the 0° clock signal 45a used at the first MZM 443. The two arms of the third MZM 60 are coupled to the two input ports of a second further 2×2 MMI 63, which operates as before to alternate the total power entering the third MZM 60 between its two output 63a, 63b, owing to the differential phase relationship of the clock signals 62a, 62b. As before, then, the power of each pulse in the input signal 47b entering the third MZM 60 is divided in half in the time domain, to provide one pulse to the first output 63a and one pulse to the second output 63b, each having a pulse duration of Ts/4 and a power equal to the original CW power. The pulses are separated by 3 Ts/4, in common with the pulses sequences 54a, 54b from the second MZM 50. However, because the pulse sequence 64a, 64b are derived from the second output 46b of the first MZM 43 instead of the first output 46a, their pulses occupy the time duration of the pulses in that second output 46b, and hence, as a pair, are delayed by Ts/2 compared to the corresponding pair of pulses in the pulses sequences 54a, 54b from the second MZM 50 which derive from the first output 46a of the first MZM 43.

Overall, therefore, the apparatus produces four pulse sequences 54a, 54b, 64a, 64b of pulses identical in power amplitude, duration and repetition rate, and each delayed with respect to the others such that the pulses of each sequence occupy a different portion of time compared to those of three other sequences, with all portions of time being contiguous. The pulses sequences can be described as being in quadrature, arising from the quadrature characteristic of the clock pulses 45a, 45b, 52a, 52b, 62a, 62b used to drive the MZMs 43, 50, 60. They are hence appropriate as channels to be combined together into a single multiplexed signal, since the pulses in each sequence interleave properly and without overlap with those of the other sequences.

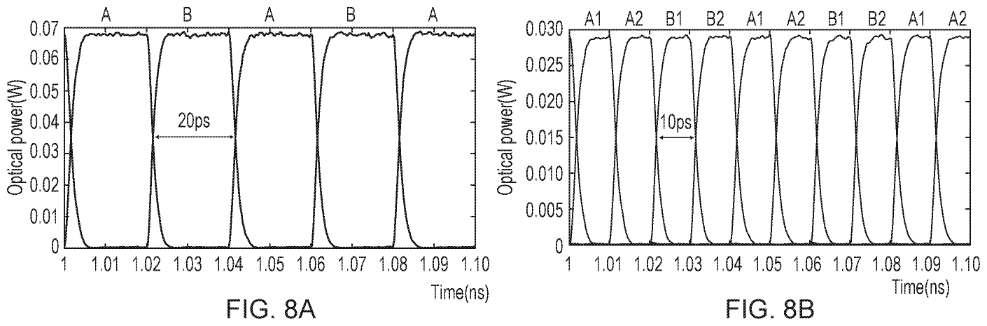

FIGS. 8A and 8B show results of a computer simulation of signals generated using apparatus of the type shown in FIG. 7. The results are represented as graphs of optical power against time. In the simulation, quadrature clock signals for driving the three MZMs had a frequency of 25 GHz, with phases set as shown in FIG. 7. FIG. 8A shows a plot of the differential pulses A and B produced respectively at the outputs 46a, 46b after the first MZM, where the clock frequency of 25 GHz gives a pulse duration of 20 ps. FIG. 8B shows a plot of the four channels of quadrature pulse sequences output by the second and third MZMs, multiplexed into a single signal. Each differential pulse A is sliced into a pair of consecutive pulses A1 and A2, and each differential pulse B is sliced into a pair of consecutive pulses B1 and B2. Since the differential pulses had a duration of 20 ps, the quadrature pulse have a duration of 10 ps, which is also directly determined by the quadrature clock pulse frequency of 25 GHz. The repeating pulse sequence A1 A2 B1 B2 is the same as the proposed sequence A B C D shown in FIG. 3.

Appropriate technology for the generation of quadrature clock signals is available. Chip-level quadrature clock generation is common in modern radio frequency communication systems. In 2014, a quadrature-voltage-controlled-oscillator (QVCO) embedded into an phase-locked-loop (PLL) and operating between 57 and 68 GHz with a 65 nm CMOS process was reported [4]. In 2016, a QVCO operating between 72 and 88 GHz based on a 28 nm CMOS process was reported [5]. In 2019, the frequency range of QVCO has been pushed to 93 to 104 GHz [6]. The effects of possible timing jitter should be taken into account for the scheme proposed herein. The current state-of-art in this area has pushed the root-mean-square (RMS) jitter to less than 0.3% of the clock period. In 2019 a PLL generating 28 to 31 GHz with a RSM jitter at 76 fs using a 65 nm CMOS process was reported [7]. Accordingly, the development of on-chip clock generation functions (implemented as QVCO plus PLL) are adequately mature for the proposed pulse generation techniques both in terms of frequency accuracy and frequency range.

Following the generation of interleaved optical pulses using methods as described above, data modulation onto the individual channels to effect OTDM can be relatively straightforward, for example by employing conventional optical pulse modulation techniques. Typically, pulse modulation is achieved by passing the train of pulses in a channel through an electro-optic modulator, and driving the modulator electrodes with one or more electrical drive signals carrying the desired data. There is no limitation of the format of modulator that can be used for this, in combination with apparatus configured to generate channels of pulses by slicing optical power in the time domain. For example, further MZMs could be used, or alternatively electro-absorption modulator (EAM) types, or ring modulator types, or metal-oxide-semiconductor capacitor (MOSCAP) types, or carrier depletion types, or carrier injection types, or other electro-optic modulator types known to the skilled person. Similarly, any appropriate material may be used for the modulator, such as silicon, group III-V semiconductors and lithium niobate.

A particularly useful approach is to use the clock source that is already utilised to generate the clock signals for driving the MZM(s) used in the pulse generation to additionally provide a trigger signal or trigger clock at the same frequency and phase to trigger the data-carrying electric drive signals (data stream) for the modulators for each corresponding pulse sequence or channel. by controlling the timing of the data streams in this way, the modulator drive signals can be interleaved with the same phase as the various pulse sequences so that the drive signals are appropriately matched in time to the pulses in each channel.

It may be that a small amount of delay mismatch may occur owing to the propagation time (delay) of the pulses from the pulse generation components to the pulse modulators. To prevent the clock pulses at the pulse modulators being a little ahead of the pulses as they arrive for modulation, an on-chip timing control function to introduce a suitable delay (tau) into the clock pulses applied to control the timing of the data streams.

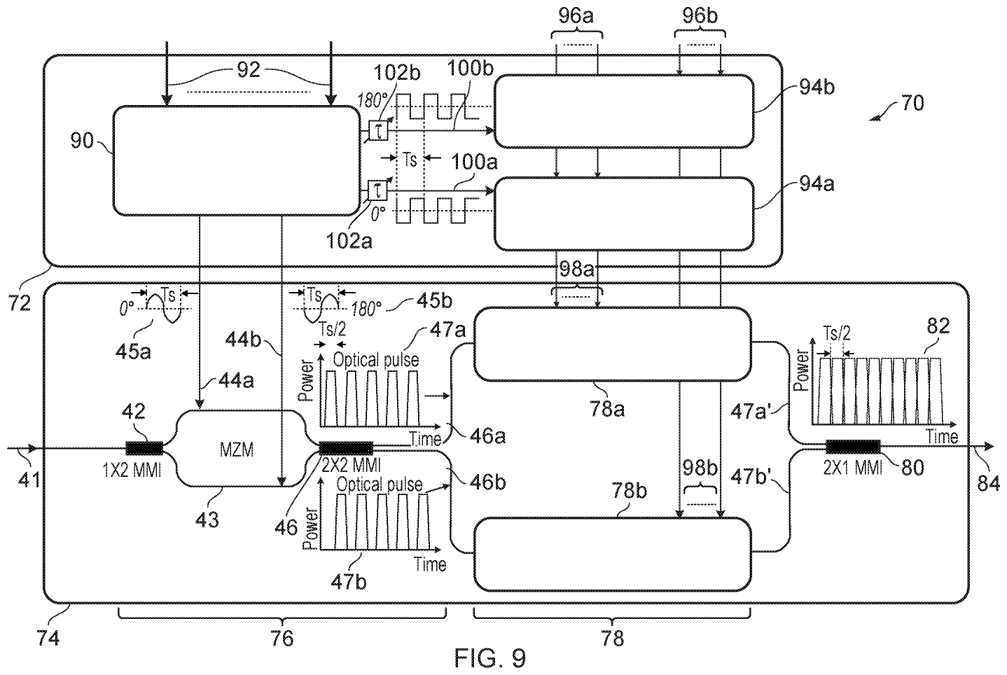

FIG. 9 shows a schematic representation of an example of an apparatus or device configured to perform OTDM based on pulse generation as described herein. In this example, two channels of pulses are produced for the final OTDM multiplexed signal. The device 70 comprises an electrical chip 72 comprising electronic components, and a photonics chip 74 comprising optical and electro-optical components, and waveguides through which light is routed for pulse generation and modulation.

The photonics chip 74 has an input port to which a CW optical signal 41 is supplied from an optical source (not shown). A pulse generator 76, configured as described with respect to FIG. 5 (so that the same reference numerals are used here for ease of comparison and understanding), is provided on the photonics chip to receive the CW optical input 41, and comprises a 1×2 MMI 42, a MZM 43 and a 2×2 MMI 46, as previously described. The MZM 43 is driven by drive signals 44a, 44b in the form of a pair of differential clock signals 45a, 45b at phases 0° and 180° and a period of Ts, also as before. The result of this arrangement, as previously, is a pair of differential pulse sequences 47a, 47b at the two outputs of the 2×2 MMI. The photonics chip 74 also includes a pulse modulator part 78, comprising a first electro-optic modulator 78a and a second electro-optic modulator 78b. The first electro-optic modulator 78a receives the first pulse sequence 47a from the first output port 46a of the 2×2 MMI 46, via a waveguide on the photonics chip 74. The first modulator 78a receives one or more electrical drive signals carrying a first data stream to be modulated onto the first pulse sequence 47a (in other words, to be carried by the first optical data channel), and outputs a modulated first pulse sequence 47a′. The second electro-optic modulator 78b receives the second pulse sequence 47b from the second output port 46b of the 2×2 MMI 46, via a waveguide on the photonics chip 74. The second modulator 78b receives one or more electrical drive signals carrying a second data stream to be modulated onto the second pulse sequence 47b (to be carried by the second optical data channel), and outputs a modulated second pulse sequence 47b′.

The two modulated pulse sequences 47a′, 47b′ are delivered via waveguides to the input ports of a 2×1 MMI 80, which combines the two modulated pulse sequences 47a′, 47b′ into a multiplexed signal 82 (amplitude modulation not shown) which comprising the pulses of the first modulated pulse sequence 47a′ interleaved with the pulses of the second modulated pulse sequence 47b′, as previously described. The multiplexed signal is delivered to an output 84 of the photonics chip 74.

The electronics chip 72 comprises an on-chip clock generator 90 comprising a phase locked loop (although other clock signal generator formats may be used if preferred), and a clock signal amplifier if necessary to achieve a suitable power level for the clock signals. Under the action of external control signals 92, the nature of which will be apparent to the skilled person, the clock generator 90 operates to generate a pair of differential clock signals (phase designated as 0° and 180° as before). The clock operates at a frequency Fs, to provide clock pulses with a period of Ts=1/Fs. The differential clock signals are provided to the photonics chip as the drive signals 45a, 45b for the MZM 43 in the pulse generator 76. Accordingly, the generated pulse sequences have a pulse duration of Ts/2, as previously described.

Copies of the differential clock signals at Ts and 0°/180° are also used to trigger the modulation applied to the pulse sequences 47a, 47b by the modulators 78a, 78b. To effect this, the electronics chip also comprises a first driver module 94a, preferably co-designed for operation with the first modulator 78a, and a second driver module 94b, preferably co-designed for operation with second modulator 78b. The driver modules 94a, 94b are configured to provide electric drive signals to the modulators 78a, 78b on the photonics chip 74 The first driver module 94a receives an external first data stream 96a, comprising data to be modulated onto the first pulse sequence or channel 47a. The modulation can utilise any known data modulation scheme, for example OOK or PAM-4. The first driver module formulates the first data stream 96a into appropriate electric drive signals 98a to drive electrodes in the first modulator 78a, and delivers these drive signals to the first modulator 78a on the photonics chip 74. Additionally, the first driver module 94a receives a copy 100a of the differential clock signal at 0° phase, which is responsible for the positions in time of the pulses in the first pulse sequence 47a, and this is used to trigger the electrical drive signals 98a for the first modulator 78a, in order that the modulation is synchronised with the timing of the pulse sequence. In order to adjust for any optical delay in the arrival of the pulses at the first modulator 78a, a variable electrical delay line 102a is provided in the supply of the clock signal 100a to the first driver module 94a. Similarly, the second driver module 94b receives an external second data stream 96b, comprising data to be modulated onto the second pulse sequence or channel 47b. The second driver module formulates the second data stream 96b into appropriate electrical drive signals 98b for the electrodes in the second modulator 78b, and delivers these to the second modulator 78b. Additionally, a copy 100b of the differential clock signal at 180° phase is provided to the second driver module 94b to trigger the drive signals 98b for the second modulator 78b, to ensure synchronicity with the timing of the second pulse sequence 47b. A second variable electrical delay line 102b can be provided to compensate for any optical delay experienced by the second pulse sequence in arriving at the second modulator 78b.

The electrical chip 72 can be three-dimensionally integrated with the photonics chip 74, in order to provide a compact and efficient OTDM device. Monolithic integration may also be used, in which the electrical components shown as being on the electrical chip 72 are monolithically fabricated with the photonics components shown as being on the photonics chip 74.

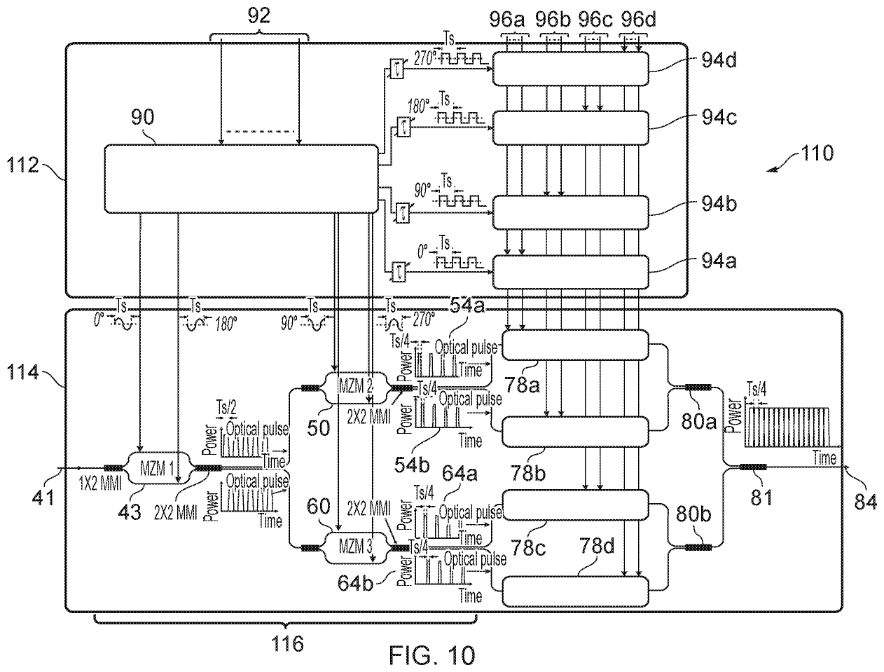

FIG. 10 shows a schematic representation of a second example of an apparatus or device configured to perform OTDM based on pulse generation as described herein. In this example, four channels of pulses are produced for the final OTDM multiplexed signal. The device 110 comprises an electrical chip 112 comprising electronic components, and a photonics chip 114 comprising optical and electro-optical components, and waveguides through which light is routed for pulse generation and modulation. The device 110 can readily be understood owing to similarities with the four-channel pulse generator of FIG. 7 and the two channel OTDM device of FIG. 9, so a detailed description is not included. In summary, however, the device 110 comprises, on the photonic chip 114, a pulse generator 116 configured as in the example of FIG. 9 to generate four quadrature pulse sequences 54a, 54b, 64a, 64b using three MZMs driven with quadrature clock signals of period Ts and relative phases of 0°, 90°, 180° and 270°, from a CW optical input 41. Each pulse sequence 54a, 54b, 64a, 64b is passed to an electro-optic modulator 78a, 78b, 78c, 78d which operate as described for the example of FIG. 9 to modulate first, second, third and fourth data streams 96a, 96b, 96c and 96d onto the respective pulse sequences. The outputs of the first and second modulators 78a, 78b are combined at a first 2×1 MMI 80a, the output of the third and fourth modulators 78c, 78d are combined at a second 2×1 MMI 80b, and the outputs of the first and second MMIs 80a, 80b are combined by a third 2×1 MMI to produce a multiplexed output 84.

The electrical chip 112 is configured as the electrical chip 72 in the example device of FIG. 9, but modified for operation with four OTDM channels. Consequently, the electrical chip 112 comprises a clock generator 90 that generates the four clock signals used to drive the MZMs 43, 50, 60. Copies of these clock signals, via variable electrical delay lines, are also provided to each of four driver modules 94a, 94b, 94c, 94d, which respectively receive the first, second, third and fourth data streams and formulate them into drive signals for the modulators 78a, 78b, 78c and 78d, triggered at the respective clock timings.

Devices such as those in FIGS. 9 and 10, monolithically integrated to provide OTDM transmitters, can be configured as silicon photonics chips with dimensions less than 20 mm per side. Example devices have been fabricated on chips of size less than 12 mm by less than 16 mm.

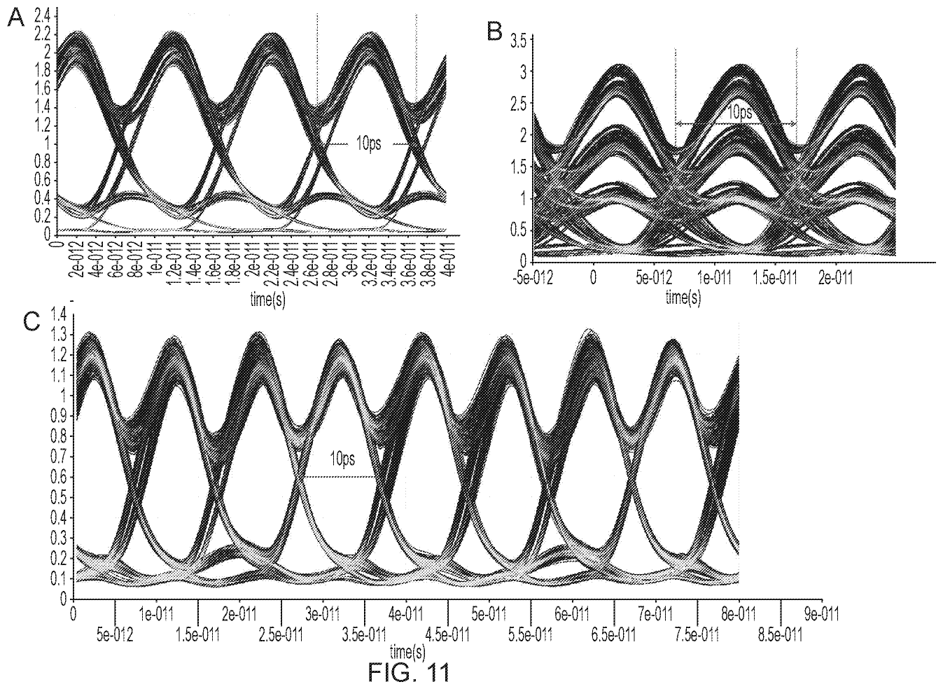

FIG. 11 shows some results of computer simulations of the operation of the example OTDM devices of FIGS. 9 and 10, in the form of “eye diagrams”, plotted as power against time. The simulations were run at different speeds for the two example circuit topologies, and additive noise sources were purposely included within each electrical data stream in order to better reflect a real scenario. FIG. 11A shows differential pulse sequences of 10 ps duration pulses (in other words, the two channel arrangement provided by the FIG. 9 circuit) modulated using 100 Gb/s OOK modulation (one segment), FIG. 11B shows differential pulse sequences (the two channel arrangement provided by the FIG. 9 circuit) modulated using 100 Gb/s (200 GB/s) PAM-4 modulation (two segments), and FIG. 11C shows quadrature pulse sequences (in other words, the four channel arrangement provided by the FIG. 10 circuit) modulated using 100 Gb/s OOK modulation (one segment). Even with the added noise, clear open eyes are obtained, indicating a good quality of modulated multiplexed output.

The presently proposed pulse generation scheme readily enables integrated device configurations such as those shown in FIGS. 9 and 10, in which components can be co-designed for optimum operation. In particular, in the implementation of a modulation scheme, the modulators and the drivers can be designed for optimum cooperation.

An example of this is a device configured to implement the known PAM-N data modulation scheme. An existing technique for this uses a continuous optical wave as an input to an electro-optic modulator. The electrodes providing modulation in the two arms of the modulator have a segmented design, comprising a series of electrode segments arranged in sequence along the length of the arms. The electrode segments are driven with signals carrying different binary inputs, as binary pulses, to be modulated onto the optical input. In order for each segment to modulate the correct part of the optical input, it is necessary to apply individual timing control functions to the drive signals for each segment, to delay the drive signals and match them to the arrival time of the optical input at that segment following its propagation delay from travelling along the modulator arm through the series of segments.

The presently proposed approach can allow the timing control to be dispensed with. A narrow optical pulse can be generated within a pulse sequence, as described above, and used as an input to the segmented modulator in place of the continuous wave input currently employed. The optical pulse will have a propagation time (delay) to travel through the modulator, passing the series of electrode segments. If the binary drive signals for the electrode segments are configured to have a pulse width which is greater than the propagation delay of the optical pulse, the optical pulse will coincide with the drive pulses of every electrode segment without any need for timing control. Hence, there is no need to match the optical and electrical delays so problems associated with delay matching are removed, and timing control functions for the drive signals can be eliminated from the device. Additionally, the wider pulse width of the electrical signals corresponds to a lower speed (frequency) for the electrical signals, which is a simpler design specification for both the driver modules and the modulator, which can be co-designed to operate at the lower speed.

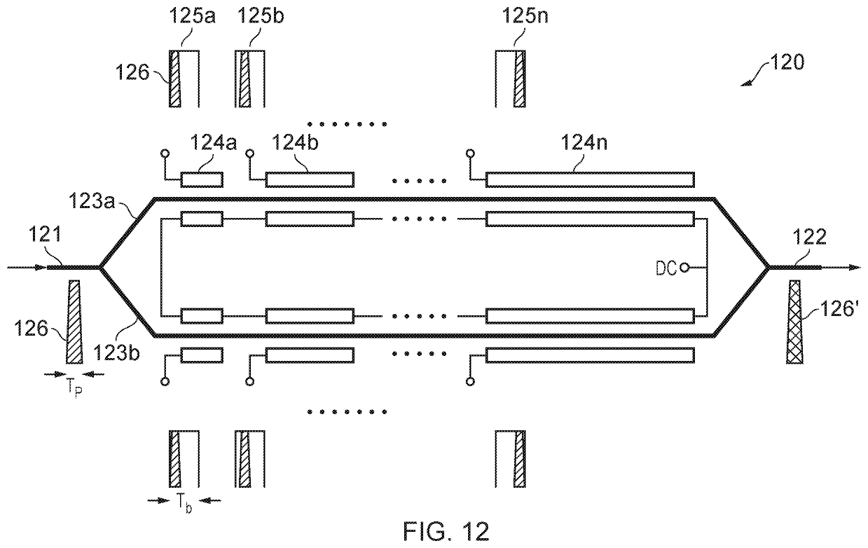

FIG. 12 shows a simplified schematic configuration of an example segmented electro-optic modulator configured to operate in this way to modulate optical pulses. The modulator 120 can be used in the modulator part 78 of the photonics chip 74 in FIG. 9, for example, being driven by appropriately configured drive module 94a, 94b on an electrical chip 72. The modulator 120 has an input 121, branching to two modulator arms 123a, 123b, which converge to an output 122, such as in a MZM. Each arm 123a, 123b has a series of electrode segments 124a . . . 124n, each comprising a pair of electrodes to one of which the binary pulse electric drive signals 125a . . . 125n are applied. Opposite polarity drive signals are applied to the corresponding electrode segments in each of the arms 123a, 123b, in conjunction with a DC bias to the other in each pair of electrode segments, in the conventional manner. The binary pulses have a width or duration Tb, and are synchronous, in other words, there is no timing delay in the pulses to the different electrode segments 124a . . . 124n. An optical pulse 126 of width Tp, less than Tb, enters the modulator input 121 and is divided between the two arms 123a, 123b. As the pulse 126 travels along the arms, it is modulated at each electrode segment 124a . . . 124n. Appropriate timing of the binary pulses 125a . . . 125n (for example using the variable electrical delay lines 102a, 102b in FIG. 9) matches the optical pulse 126 to the first portion of the binary pulse 125a at the first electrode segment 124a. As the optical pulse 126 propagates along the modulator arms 123a, 123b, it experiences optical delay, and hence overlaps with increasingly later portions of the binary pulses 125b . . . 125n of successive electrode segments 124b . . . 124n. The optical pulse 126 moves through the pulse width of the electric binary pulses as it traverses the electrode segment series. For an appropriate selection of the binary pulse width Tb with regard to the optical delay through the modulator, at the last electrode segment 124n the optical pulse 126 overlaps with the last portion of the binary pulse of the final drive signal 125n. The optical pulse leaves the modulator 120 in modulated form 126′ at the modulator output 122.

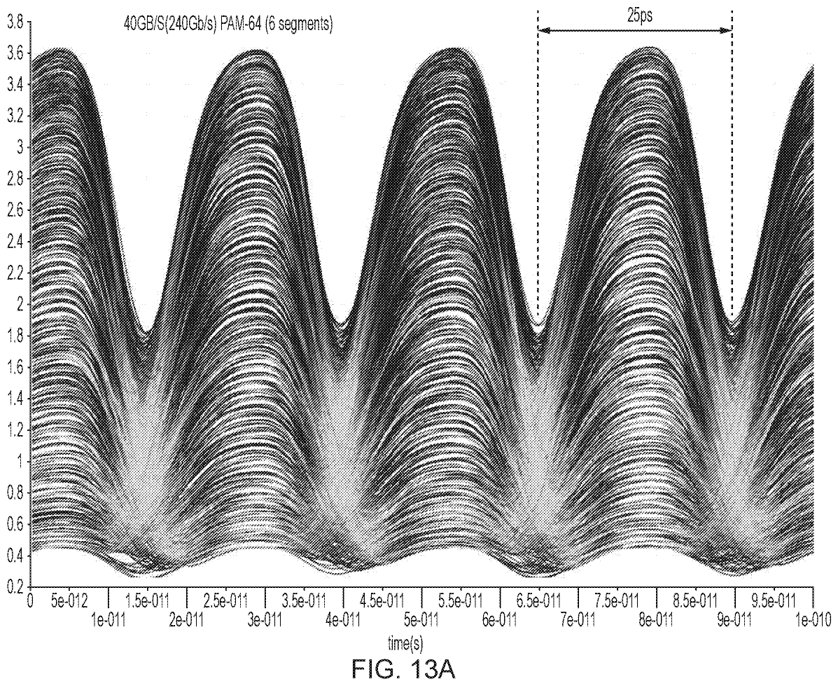

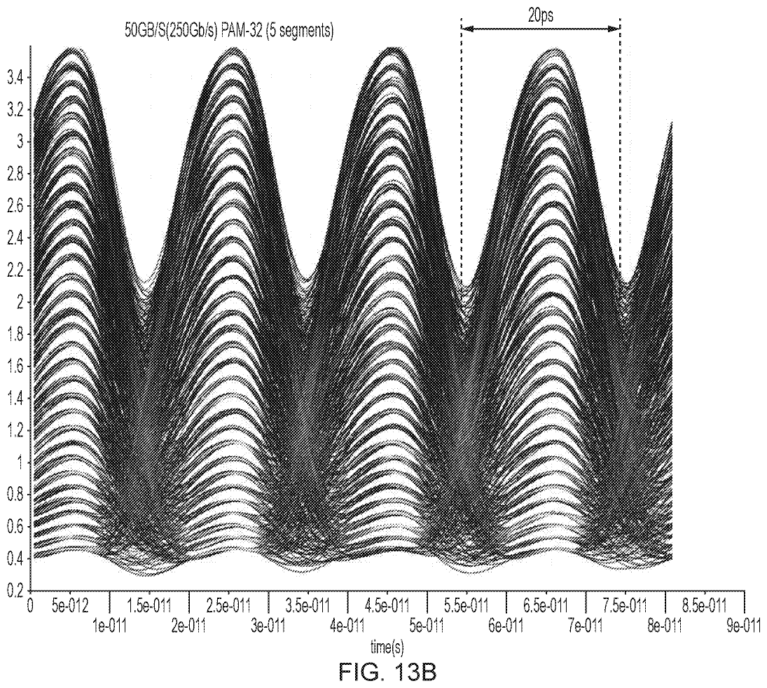

FIG. 13 shows the results of computer simulations of PAM-N modulation schemes performed using segmented modulators of the type shown in FIG. 12 together with pulse generation as in the FIGS. 9 and 10 arrangements, as plots of power against time. Figure A shows 25 ps optical pulses modulated with a six-segment modulator to achieve PAM-64 modulation, at a baud rate of 40 GB/s and bit rate of 240 Gb/s. Figure B shows 20 ps optical pulses modulated with a five-segment modulator to achieve PAM-32 modulation, at a baud rate of 50 GB/s and bit rate of 250 Gb/s. As can be seen, modulation of successive bits remains clean and properly timed, even without any timing delay compensation between the optical and electrical pulses.

The example modulators of FIGS. 9 and 10 can be considered as digital-to-analogue converters: the input data streams carry digital information which is modulated onto the amplitude of the optical pulses to form a corresponding analogue output. The proposed pulse generation scheme can also be utilised in analogue-to-digital conversion. It is proposed that an analogue electrical input signal be modulated onto the optical pulse amplitude, which is then used to generate a corresponding electrical digital binary output.

The pulse modulation is operated as optical sampling of the analogue input. In existing photonic (optically-based) analogue to digital converters (ADC), sampling in the optical domain by using optical pulse trains is used to overcome aperture jitter in electrical sampling ADC schemes; this is considered generally advantageous. Typically, such systems are based on discrete components. In contrast, arrangements proposed herein offer chip-level ADC products able to operate with an accumulated sampling rate in excess of 100 GB/s, combined with the benefit of frequency tunability discussed above with regard to the OTDM systems.

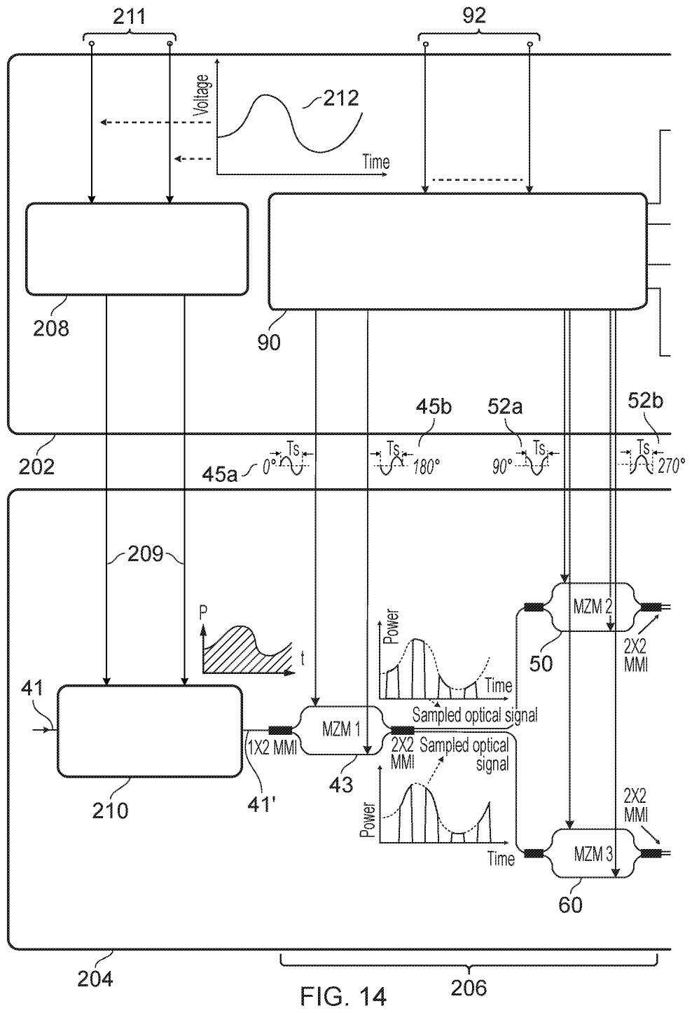

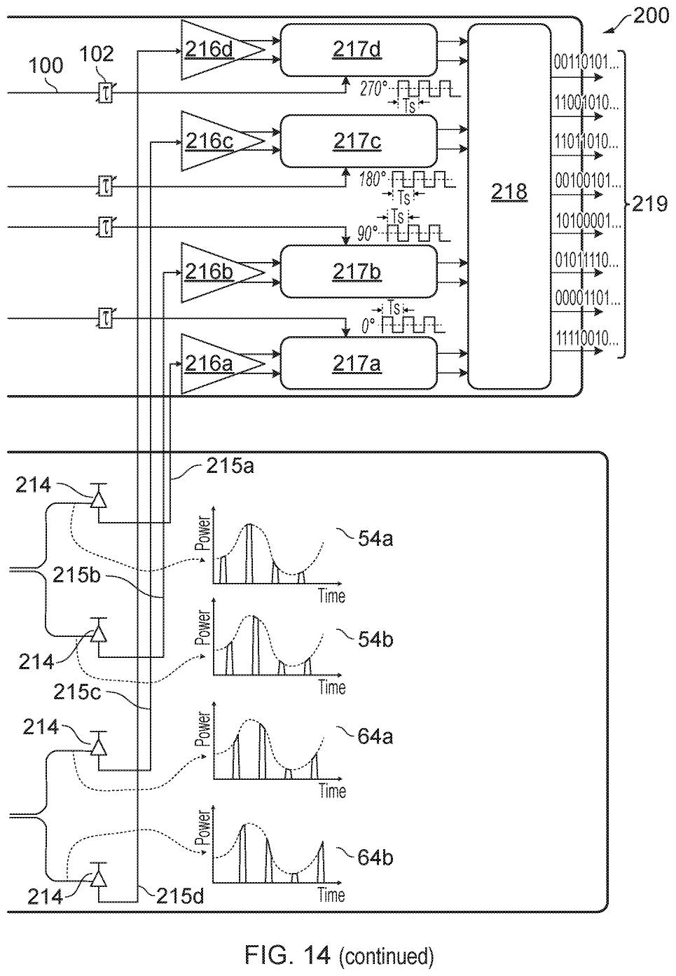

FIG. 14 shows a simplified schematic representation of a first example ADC system 200. As before, the system comprises an electrical chip 202 and a photonics chip 204, which may be three-dimensionally integrated. The system is configured such that the optical CW input is amplitude modulated with one electrical analogue input before it is used to generate pulse sequences.

Central to the system 200 is a quadrature optical pulse generator 206, configured in line with the FIG. 7 example, and therefore comprising three MZMs 43, 50, 60 on the photonic chip 204 which are driven by quadrature clock signals 45a, 45b, 52a, 52b from an on-chip clock generator 90 on the electronics chip 202 driven by external control signals 92, as previously described. Also as previously described, the pulse generator 206 operates to generate four quadrature pulse sequences 54a, 54b, 64a, 64b from an input CW optical signal 41. However, the electrical chip additionally comprises an input driver module 208 which generates drive signals 209 for an input electro-optic modulator 210 on the photonics chip 204 in response to an electrical analogue input 211 supplied to the input driver module 208. The electrical analogue input 211 has a modulated voltage 212 representing the analogue input of interest. The input modulator 210 receives the CW optical input 41, having a constant power amplitude, and under the action of the drive signals 209, acts to generate a modulated CW optical input 41′, having a power amplitude modulated in correspondence with the modulated voltage of the electrical analogue input 211. The modulated CW optical input 41′ is delivered to the pulse generator 206, so that the differential pulse sequences output by the first MZM 43 and the subsequent quadrature pulse sequences 54a, 54b, 64a, 64b from the second and third MZMs 50, 60 have the same amplitude modulation, as a variation of power over time, as the original modulated voltage of the electrical analogue input 211. The pulse sequences comprise optical pulses interleaved in time that correspond to the original analogue signal, so that optical sampling of the analogue signal has been achieved, the samples distributed over four optical channels.

In order to effect conversion of the optical analogue samples into the digital domain, each pulse sequence 54a, 54b, 64a, 64b is delivered to a corresponding photodetector 214 (such as a photodiode) on the photonics chip. These detect the optical power of the pulse sequences 54a, 54b, 64a, 64b and output correspond electrical signals 215a-215d. Each electrical signal 215a-215d is routed to a corresponding electrical amplifier, such as a transimpedance amplifier 216a-216d, the outputs of which, being amplified versions of the electric signals 215a-215d are delivered to corresponding electrical analogue-to-digital converters (ADC) 217a-217d also on the electrical chip 202. The ADCs 217a-217d operate in the conventional manner to convert the input electrical signals 215a-215d, being analogue signals representing each optical pulse sequence 54a, 54b, 64a, 64b, into electrical binary signal outputs. Each binary output is passed to a single digital signal processor 218, which may also comprises memory for storage of the binary signals. The processor 218 is configured to perform any signal processing deemed necessary for the binary signals, and provide the result as a series of electrical digital binary outputs 219, being the final digital output of the system 200. In order to ensure that the operation of the ADCs 217a, 217d is properly synchronised with the relative timings of each pulse sequence 54a, 54b, 64a, 64b the ADCs are triggered with clock signals 100 from the clock generator 90 matching the quadrature clock signals 45a, 45b, 52a, 52b used to drive the pulse generator MZMs 43, 50, 60, optionally passed through variable electrical delay lines 102 to compensate for optical propagation delays on the photonics chip 204. This is analogous to the timing control used to trigger the OTDM modulators 78 in the FIGS. 9 and 10 examples.

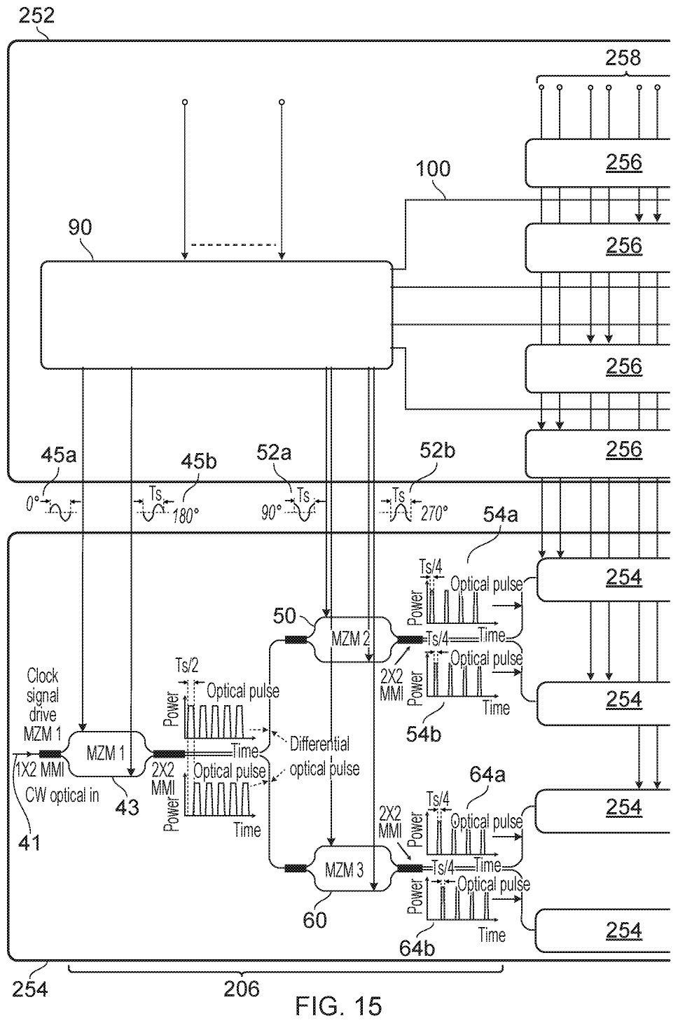

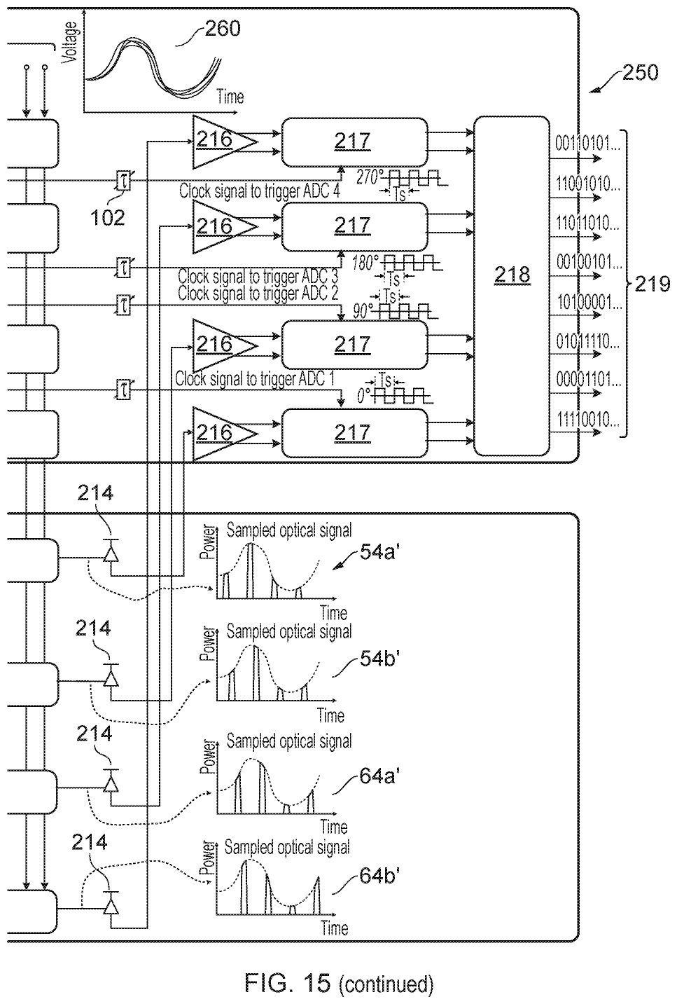

FIG. 15 shows a different arrangement to that of FIG. 14, in which optical pulse sequences are generated from the CW optical input and then modulated with multiple electrical analogue inputs to achieve the optical sampling, which is then analogue-to-digital converted. Again, the system 250 comprises an electrical chip 252 and a photonics chip 254. As in the FIG. 14 example, a quadrature optical pulse generator is included, operable to generate four quadrature channels of interleaved optical pulses from three MZMs 43, 50, 60 on the photonics chip 254 driven with quadrature clock signals 45a, 45b, 52a, 52b from a clock generator 90 on the electrical chip. The optical CW input 41 to the pulse generator 206 has a constant power amplitude, so that the four pulse sequences 54a, 54b, 64a, 64b comprise pulses of equal power, without modulation. Each pulse sequence is passed to a corresponding electro-optic modulator 254 on the photonics chip. While this is similar to the FIG. 10 arrangement, in this case the modulators 254 are driven via driver modules 256 on the electrical chip 252 which are provided with electrical analogue inputs 258 to be modulated onto the four channels of pulses, in place of the electrical digital data streams input for driving the modulators in the OTDM device. As before the drive modules 256 can be co-designed with their corresponding modulators 254 for optimised performance. The electrical analogue inputs 258 may reflect a single source or multiple correlated sources, to provide modulated voltage inputs 260. Since the inputs 258 driving the modulators are analogue in this instance, there is no requirement to ensure synchronicity with the optical pulses and the drive modules 256 are not therefore triggered with clock signals from the clock generator 90.

The output from the modulators 254 are therefore four channels of time interleaved quadrature optical pulse sequences 54a′, 54b′, 64a′, 64b′, modulated to carry the electrical analogue inputs 258. The conversion to digital signals is carried out in the same manner as in the FIG. 14 system. Hence, each channel of pulses is captured by a photodetector 214 on the photonics chip 254, the electrical outputs of which are passed to transimpedance amplifiers 216 on the electrical chip 252. The amplified electrical signals are delivered to corresponding ADCs 217 on the electrical chip for conversion to binary outputs which are received by a digital signal processor 218 also on the electrical chip. This delivers the final digital output 219 of the system 250. As before, the ADCs 217 are triggered with the appropriate quadrature clock signals 100 from the clock generator 90 for proper timing with the pulse sequences.

As will be appreciated from a comparison of FIG. 14 with FIG. 15, the photonic ADC system shown in FIG. 15 includes more components, so requires a greater chip area. Implementing the modulation to import the analogue signals after the pulse sequence generation rather than before requires more modulators, and hence introduces a higher overall optical loss. However, the FIG. 15 system offers the possibility that multiple correlated analogue inputs, one per optical channel, can be digitised with one single ADC device, compared to the single analogue input handled by the FIG. 14 system. This may find application in radar systems, for example, in which “multiple input multiple output” (MIMO) techniques have been widely adopted.

Various experimental work has been carried out to demonstrate the practicality of the disclosed pulse generation technique and associated modulation methods. The production, in terms of fabrication and packaging, of commercially suitable optoelectronic devices and systems will require significant development work, but nevertheless it is possible to demonstrate the disclosed concepts with real devices. Therefore, a previously fabricated silicon modulator array on a chip has been used a core module component for proof of principle demonstrations. This silicon modulator chip, in which four individual MZMs are fabricated as an array, was wire-bonded onto a printed circuitry board (PCB). External electrical clocks and data streams were routed to the modulators via radio frequency (RF) tracks (grounded coplanar waveguide) on the PCB. RF losses in the PCB and parasitic effects introduced by the device packaging limited the modulators to operation up to a few Gb/s, which is nevertheless useful to allow proof of concept.

Three demonstrations were made: generation of differential optical pulses (corresponding to FIG. 5), generation of quadrature optical pulses (corresponding to FIG. 7), and OTDM based on differential optical pulses (corresponding to FIG. 9).

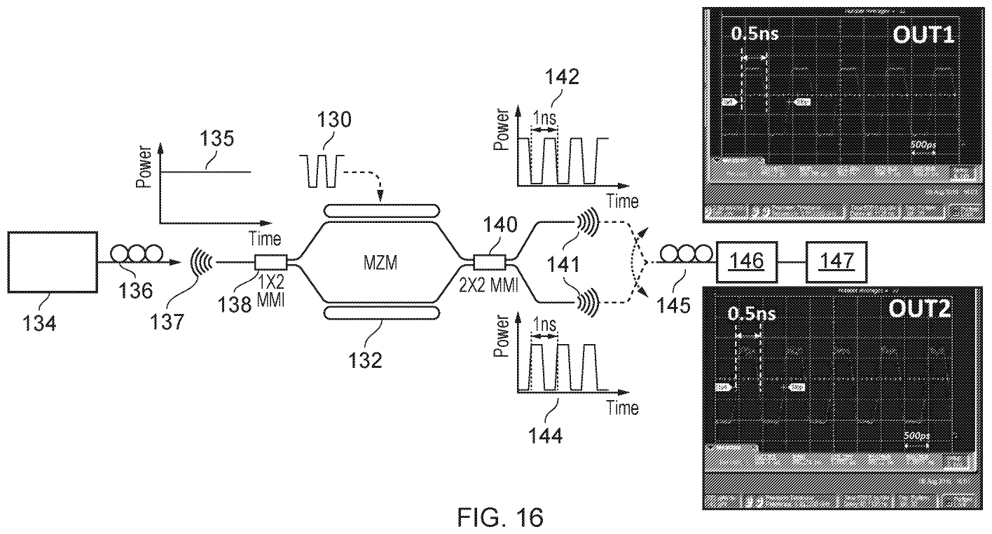

FIG. 16 shows a schematic representation of experimental apparatus configured to demonstrate the generation of differential optical pulses. An external 1 GHz differential clock signal 130 with a clock period of 1 ns was applied to drive a first MZM 132 with peak-to-peak voltage (Vpp) of about 5.0 V. An optical source 134, in the form of a laser, output continuous wave optical power 135 at a wavelength of 1310 nm. This was passed through a polarising fibre 136 before being input to the MZM 132 via grating coupler 137 and a 1×2 MMI 138. After modulation in the MZM, the optical power leaves the MZM 132 via a 2×2 MMI 140, which, as described above, creates two output channels 142, 144 of alternating optical pulses. Theoretically, these differential optical pulses are generated from the 2×2 MMI simultaneously. However, only one input port of a digital communication analyser (DCA) was available, so the output waveforms, leaving the device via output grating couplers 141, could be observed only at a time. The pulses leaving either grating coupler 141 were fed to the DCA 147 via an optical fibre 145 and an erbium doped fibre amplifier 146. The results of observing each of the channels 142, 144 is shown in FIG. 16 as screen shoots from the DCA. Since they are observed individually, it is not possible to observe the relative timings of the pulses, so instead the observations focused on the shape and width of the optical pulses in each channel. As highlighted on the screen shots, the width of the observed optical pulses in each channel is exactly the same, namely 0.5 ns, which is half of the 1 ns clock period. This shows the functionality of the differential optical pulse generation.

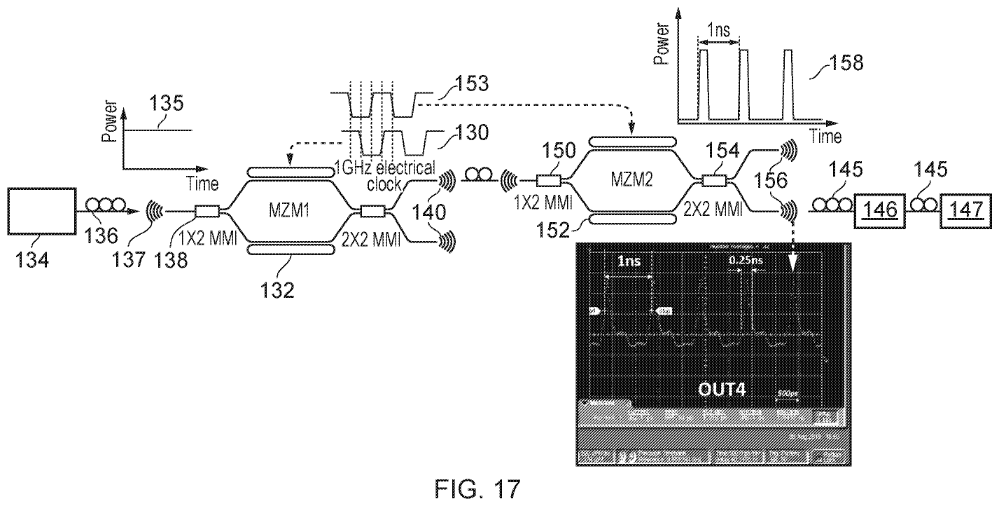

FIG. 17 shows a schematic representation of experimental apparatus configured to demonstrate the generation of quadrature optical pulses. The apparatus corresponds to that of FIG. 16, with extended functionality to generate quadrature pulse from the differential pulses, as described with reference to FIG. 7. Once again, an external 1 GHz differential clock signal 130 with a 1 ns period was applied to the MZM 132 (now a first MZM) with a Vpp of about 5.0V. One of the output differential pulse sequences was extracted via an output grating 140 from the first MZM 132 and input via a fibre to a second 1×2 MMI 150 and subsequent second MZM 152. The second MZM 152 was driven using the same clock source, with the clock signal phase shifted by 90° (one quarter of the clock cycle), in order to provide a quadrature clock signal 153. The second MZM 152 output via a second 2×2 MMI, the output ports of which, via output gratings 156, delivered two quadrature optical pulse sequences 158 as previously described. The pulse sequence 158 from one output grating 156 was observed on the DCA, and a screen shot of the result is included in FIG. 17. Theoretical analysis of the quadrature generation process indicates that the width of the optical pulses from the second MZM 152 and second 2×2 MMI 154 should be equal to one-quarter of the clock cycle. This is demonstrated in the screen shot, where a pulse width of 0.25 ns (one quarter of the 1 ns clock period) is indicated. The distorted shape of the observed quadrature optical pulses is not of concern, since it arises from a provision of only 3.5 Vpp from an RF amplifier utilized to drive the second MZM 152; this was insufficient for the required modulation depth.

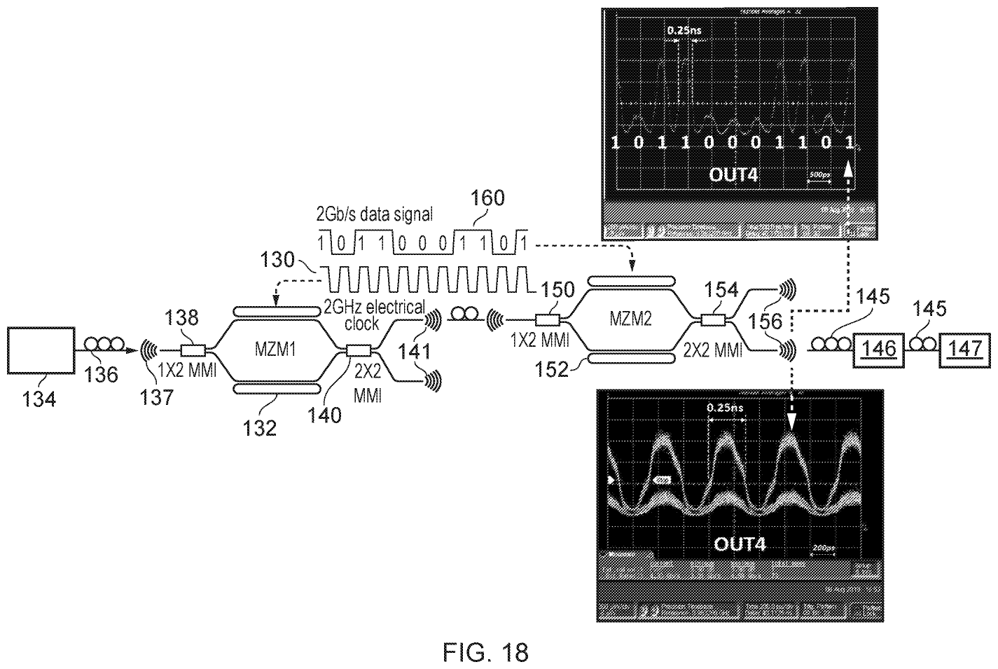

FIG. 18 shows a schematic representation of experimental apparatus configured to demonstrate OTDM, based on the differential pulse sequences generated from the apparatus of FIG. 16. The apparatus corresponds to that of FIG. 16, with extended functionality to perform OTDM. To achieve this, the apparatus was configured as in the FIG. 17 example, by adding the second MZM 152 at one of the differential pulse sequence outputs from the first MZM 132. However, the second MZM 152 was driven with a drive signal representing a desired data stream, rather than with a quadrature clock signal as in FIG. 17, so as to operate as a modulator such as the modulators 78a, 78b in FIG. 9, rather than the quadrature-generating modulator in FIG. 17. In order to generate the differential pulse sequences, the first MZM 132 was in this instance driven using a differential clock signal at 2 GHz, to give a clock period of 0.5 ns. This higher clock frequency gave a shorter differential pulse width, of 0.25 ns. Pulses of this duration comprised in one of the differential pulse sequences from the first 2×2 MMI following the first MZM 132 were delivered to the second MZM 152 to undergo amplitude/power modulation. The second MZM was driven with electric drive signals 160 applied to its electrodes which carried a data stream or signal that could be triggered by the 2 GHz clock signal 130, and hence having a bit rate of 2 Gb/s. The data stream drive signal 160 was synchronised with the clock signal 130 by aligning the rising edges of the two signals, to emulate the clock triggering arrangement described with respect to FIGS. 9 and 10 (wherein the clock signal used to generate the pulse sequences is also used to trigger the data streams applied to the modulators). The optical waveform obtained at one of the output grating couplers 156 of the second MZM 152/second 2×2 MMI 154 was observed on the DCA 147. Screen shots of the results are included in FIG. 18. Theoretical analysis of the OTDM process indicates that the input data stream 160 should be modulated onto the differential optical pulses, the width of which is determined by the clock signal applied to the first MZM 132. In this experiment, with a 2 GHz clock signal, the width of the differential optical pulses, and hence the pulse width in the modulated data stream, is expected to be 0.25 ns; this was observed, as highlighted on the screen shots. Also, the binary sequence of the input data stream, 10110001101, is clearly modulated onto the observed pulses shown in the upper screen shot.

Consequently, the principle described with respect to FIG. 9 was demonstrated, namely that a “full” rate OTDM transmitter device can be built with each modulator in the device operating at half of that data rate.

This experimental work was based on general discrete component at hand, for the purpose of proof of concept only. Neither the operation speed nor the signal integrity demonstrated correspond to those of modern optical communication links, but the demonstrated devices can be readily scaled and enhanced to provide performance up to and beyond current communications link operating parameters. As noted, devices to implement the described methods and techniques can fabricated by monolithic integration of electrical components into silicon photonics platforms or via three-dimensional packaging of optoelectronic systems.

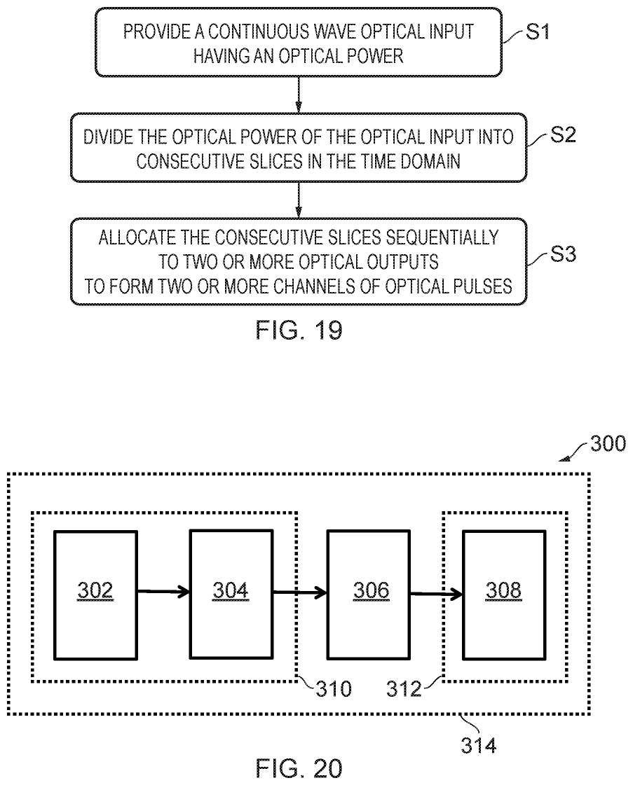

Optical pulse generation in accordance with the method proposed herein can be understood with reference to the flow chart shown in FIG. 19, which shows steps in a pulse generation method by which multiple channels of optical pulses can be generated. In step S1, an optical input in the form of continuous wave optical input with an optical power is provided. This may the output of a laser, for example. In many cases, the optical power of the optical input will be substantially constant, but for some applications such as the ADC demonstrated with reference to FIG. 14, the optical power may be modulated in amplitude, for example to encode an analogue signal. In step S2, the continuous wave optical power of the optical input is divided into equal consecutive slices in the time domain. Each slice may be thought of an optical pulse, each slice or pulse being contiguous in time with the preceding and following slice or pulse. In step S3, the consecutive slices are allocated sequentially to two or more optical outputs. This allocation evenly distributes the slices across the outputs so that each output comprises a series or sequence of identical pulses at the same repetition rate, but with the timing of the pulses in each output offset or delayed with respect to the sequence(s) in the other output or outputs. Each sequence can be designated as a channel of optical pulses, suitable for modulation to carry data in a communications network, for example. In particular, the pulse timing in the sequences that arises from the sequential allocation of the slices between the channels means that the pulses are interleaved in time and the channels can be combined in a multiplexed manner with no timing overlap between the pulses of different channels.

A variety of apparatus configurations for generating optical pulses of this form have been described herein, together with additional features for enabling applications such as digital to analogue conversion, analogue to digital conversion and optical time domain multiplexing. However, it is envisaged that other configurations of apparatus, comprising various photonic and electrical components and devices, may alternatively be used to generate pulses in accordance with a method as set out in FIG. 19, in other words, by slicing a continuous wave optical power signal into consecutive parts, portions or slices for distribution across a plurality of channels, where each slice forms an optical pulse that preserves or substantially preserves the optical power level of the original continuous wave optical signal, thereby maximising the modulation depth available for modulating information on the pulses.

For example, the various pulse generators described herein in detail comprise Mach Zehnder modulators (MZMs). Other electro-optic modulators that achieve the same results as MZMs are known, and may be used instead as preferred. The various components may be differently distributed between one or more chips to produce a complete device, with individual chips integrated together in any known manner considered practical and convenient. While devices in a chip-based format are compact, robust and convenient, a device or apparatus configured to achieve the proposed pulse generation could be implemented to include one or more bulk optical or electrical components.

The example OTDM transmitters described above with regard to FIG. 9 (two channel) and FIG. 10 (four channel) were discussed in terms of identical modulation being applied to each channel in order to generate the multiplexed output. Electro-optic modulators are provided with driver modules configured to provide electric drive signals to the modulators, such that each driver module receives an external data stream comprising data to be modulated onto the first pulse sequence or channel.

However, the transmitters are not limited in this regard. A particular benefit of the approach described herein is that different modulation techniques can be applied to different channels generated in the same OTDM device, and/or different data types can be modulated onto the different channels, without any impact on the ability to multiplex the channels and transmit the final output signal. All that is required are appropriate drive signals that can carry the desired data streams, and suitable modulators or signal processing units able to imprint or encode that data onto the optical pulses. In particular, it is possible to modulate individual channels in the same transmitter simultaneously with either digital signals or analogue signals. This is a highly beneficial flexibility enabled by the use of optical signals to carry the data. Similar electrical multiplexing systems, such as electrical serialisers/deserialisers (SERDES) are typically built from semiconductor logic gates (complementary metal-oxide-semiconductors (CMOS), for example) and are hence only able to handle binary information and are therefore limited to digital applications. Devices according to the present disclosure are not limited in this way, and both digital data and analogue data can be encoded onto the optical pulse sequences by use of suitable modulators. For example, the pulses of one channel can be modulated with a binary signal, pulses in another channel can be modulated with an analogue signal such as a radio frequency signal, and pulses in yet further channels can be modulated according to other modulation schemes such as pulse-amplitude modulation (PAM) or quadrature amplitude modulation (QAM). Once individually modulated, the channels can be multiplexed and later demultiplexed free from interference with one another (channel cross-talk). This capability to handle different signal types and formats has the potential to greatly enhance and improve computing architecture; allowing the efficient routing of many signals, with reduced requirements for analogue-to-digital conversion and digital-to-analogue conversion. This is merely one example application, however, and the invention is not limited in this regard.

An OTDM device as proposed herein can be thought of an optical serialiser (the serialising or multiplexing side of a SERDES system), and offers several advantages over conventional logic-gate based electrical serialisers. An electrical device typically suffers from latency induced by latch-up in the CMOS components; an optical system eliminates this. Higher throughput can be achieved in an optical arrangement compared with an electrical arrangement. The optical signals are immune to electromagnetic interference. Also, the use of optical signals gives compatibility with optical wavelength division multiplexing schemes.

To fully implement SERDES or other schemes that transmit, convey or propagate the multiplexed signal, demultiplexing or deserialisation is required, wherein the multiplexed signal is received and demultiplexed or deserialised back into its individual component channels so that the data carried by the optical pulses in each channel can be extracted and utilised, or the pulses of any channel can be separately further conveyed elsewhere.

FIG. 20 shows a schematic block diagram of a full optical multiplex and demultiplex or SERDES system according to an example of the current disclosure. From left to right, the system 300 comprises an optical pulse generation component or element 302, a multiplexing component or element 304, a routing component or element 306, and a demultiplexing component or element 308. The optical pulse generation component 302 may, for example, be configured to generate two channels of pulses as in the example of FIG. 5 or the pulse generator 76 in FIG. 9, or four channels of pulses as in the example of FIG. 7 or the pulse generator 116 in FIG. 10, or similarly but expanded with additional modulator stages to generate additional channels. The multiplexing component 304 receives the channels of optical pulses from the optical pulse generation component 302, modulates the pulses of each channel to encode data therein, and combines the pulses from all the channels in a interleaved manner to create a multiplexed signal. It may be configured, for example, in line with the modulator part 78 shown in FIG. 9 (two channels) or FIG. 10 (three channels), or expanded to handle more channels. The routing component 306 receives at an input end the optical multiplexed signal output by the multiplexing component 304 and propagates it to the intended destination, which may be nearby to the pulse generator 302 and multiplexer 304, or remote therefrom. Propagation may be via one or more optical planar or channel waveguides formed in one or more chips, or via one or more optical fibres, or a combination of the two, depending on the application and the distance over which the multiplexed signal needs to be transmitted. An output end of the routing component 306 delivers the transmitted multiplexed signal to the demultiplexing component 308.

The components may be variously fabricated on one or more chips depending on the application. For example, if the multiplexed signal is to be propagated a significantly greater distance than typical chip dimensions, or propagated for a distance unknown in advance, the optical pulse generator component 302 and the multiplexing component 304 may be formed on a first chip 310, and the demultiplexing component 308 may be formed on a separate, second chip 312. This gives flexibility in locating the multiplexing and the demultiplexing functionality of the system 300. The routing component 306 can be fabricated as required according to the type and distance of propagation, and optically coupled to the first chip 310 and the second chip 312. In another example, all the components may be fabricated on single chip 314 in order to provide a monolithic optical SERDES system.

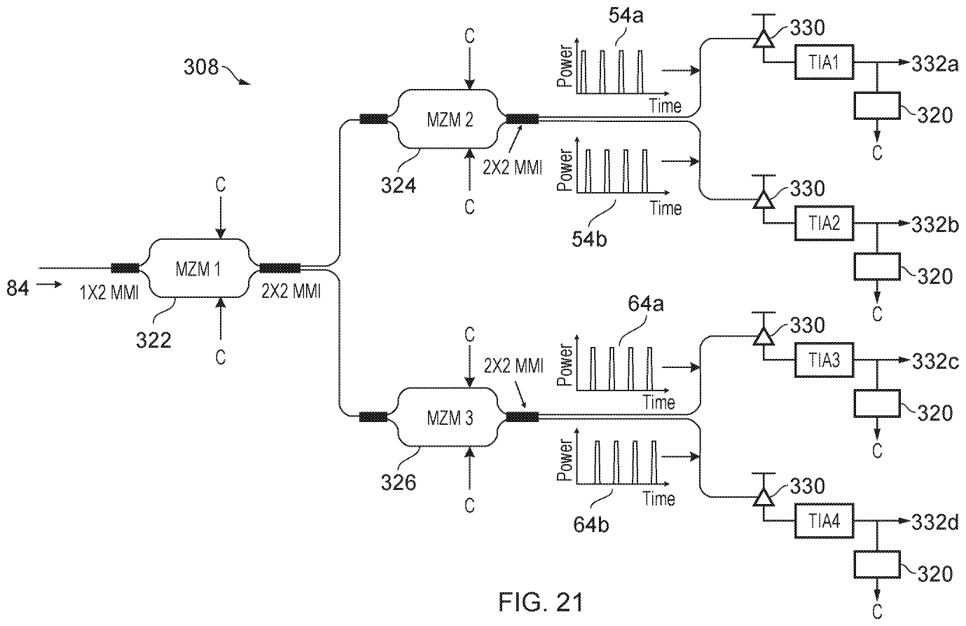

FIG. 21 shows a schematic representation of an example of a component, element or device configured to perform demultiplexing or deserialisation of a multiplexed signal generated by OTDM as described herein, such as may be used in the demultiplexing component 308 in the optical SERDES system 300 shown in FIG. 20. In order to achieve successful demultiplexing or deserialisation of a multiplexed signal, it is generally considered appropriate to utilise a clock signal to retain the appropriate relative timings of the pulses belonging to the various channels. In electrical SERDES systems, this is achieved by encoding a clock signal or timing information into the data carried by the various channels, extracting this information during deserialisation, and using it to set the pulse timings in the channels. In the current arrangement, it is proposed to do the same. Accordingly, the multiplexing end of the system is configured to include clock data into the modulated optical pulses of each channel. The demultiplexer 308 an input, where the multiplexed signal 84 is received after routing, plus outputs where each of the individual signals is delivered in electrical form 332a-332d after demultiplexing. Each output includes a clock and data recovery (CDR) module or circuit 320 which extracts the clock data from each demultiplexed signal and generates a relevant clock signal C for use in the demultiplexing. Alternatively, a single CDR circuit may be includes which is configured to generate multiple clock signals at the various different phases.

For demultiplexing, a similar arrangement is employed to that used to generate the multiple channels of pulses from the original CW optical input, with the multiplexed signal 84 being treated as the CW input. Compare FIG. 21 with FIG. 17. Hence, the multiplexed signal 84 enters a first demultiplex module 322 comprising a 1×2 MMI device that distributes the optical power of the multiplexed signal between two arms of a MZM, the outputs of which are passed through a 2×2 MMI. However, in this instance, the arms of the MZM are driven each appropriately driven by a clock signal C from the CDR or CDRs in order to preserve the pulse timing of the multiplexed signal. Each output from the 2×2 MMI is passed to another demultiplex module 324, 326, again each comprising a 1×2 MMI, a MZM and a 2×2 MMI, with the arms of the MZM each also being appropriately driven by the clock signal C. The 2×2 MMI each have two outputs, as before, each of which provides the optical pulses from one of the original channels 54a, 54b, 64a, 64b, the original pulse widths, spacing and modulation being preserved. In order to utilise the channels, the pulses of each are incident on a dedicated photodetector 330 each having an associated transimpedance amplifier 332 and configured to measure the power amplitude of each pulse. Since the amplitudes are determined by the modulation applied to the pulses in the original pulse generation and multiplexing stage, the data encoded by that modulation can be extracted from each channel, and delivered at the electrical outputs 332a-332d.

An optical SERDES or multiplex/demultiplex system in line with the examples herein offers a variety of possible functionalities and benefits. It is attractive for use in computing architecture, for example. In conventional electronics-based computing architecture, data is transmitted and processed in the form of binary logic bits represented by 0 and 1; data is limited to this format. In a photonics-based system, on the other hand, data is transmitted and processed in the form of optical pulses, which can carry complex degrees of freedom, thereby removing restrictions created by binary bits. However, the devices described herein are additionally compatible with traditional binary signals (which are merely one of many data formats that can be carried by optical pulses), offering a smooth transition between electrical and optical devices and systems. While generally useful, this is attractive for current fields of interest such as analogue computing, optical machine learning and artificial intelligence.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in the future.

### REFERENCES

[1] J Verbist et al, “4:1 silicon photonic serializer for data center interconnects demonstrating 104 Gbaud OOK and PAM4 transmission”, Journal of Lightwave Technology, vol. 37, pp 1498-1503, 2019
[2] J Meier and T Schneider, “Precise, High-bandwidth digital-to-analog conversion by optical sinc-pulse sequences”, 2019 12^{th} German Microwave Conference (GEMiC), March 2019
[3] MA Soto et al, “Generation of Nyquist sinc pulses using intensity modulators”, Conference on Lasers and Electro-optics, 2015
[4] X. Yi, C. C. Boon, H. Liu, J. F. Lin, and W. M. Lim, “A 57.9-to-68.3 GHz 24.6 mW Frequency Synthesizer With In-Phase Injection-Coupled QVCO in 65 nm CMOS Technology”, IEEE Journal of Solid-State Circuits, vol. 49, no. 2, pp. 347-359, February 2014.
[5] M. Vigilante, and P. Reynaert, “Analysis and Design of an E-Band Transformer-Coupled Low-Noise Quadrature VCO in 28-nm CMOS”, IEEE Transactions on Microwave Theory and Techniques, vol. 64, no. 4, pp. 1122-1132, April 2016.
[6] X. Yi, “A 93.4-104.8-GHz 57-mW Fractional-N Cascaded PLL With True In-Phase Injection-Coupled QVCO in 65-nm CMOS Technology”, IEEE Transactions on Microwave Theory and Techniques, vol. 67, no. 6, pp. 2370-2381, June 2019.
[7] J. Kim, H. Yoon, Y. Lim, Y. Lee, Y. Cho, T. Seong, and J. Choi, “A 76 fs(rms) Jitter and-40 dBc Integrated-Phase-Noise 28-to-31 GHz Frequency Synthesizer Based on Digital Sub-Sampling PLL Using Optimally Spaced Voltage Comparators and Background Loop-Gain Optimization”, IEEE International Solid State Circuit Conference 2019, p. 258

1. A method of generating multiple channels of optical pulses, comprising:
providing a continuous wave optical input having an optical power;
dividing the optical power of the optical input into equal consecutive slices in the time domain; and
allocating the consecutive slices sequentially to two or more optical outputs such that each output forms a channel of optical pulses of equal pulse repetition rate shifted in time relative to the or each other channel.

2. A method according to claim 1, further comprising modulating the optical power amplitude of the optical pulses in at least one channel to encode information.

3. A method according to claim 1, in which the optical power amplitude is modulated to encode binary data, the method further comprising combining the channels by interleaving the optical pulses in time to form a multiplexed signal comprising all the optical pulses.

4. A method according to claim 1, in which the optical power amplitude is modulated to encode one or more analogue electrical signals, the method further comprising converting a power measurement of the optical pulses in each channel into a digital output signal.

5. A method according to claim 4, in which the one or more analogue electrical signals comprises an analogue electrical signal modulated onto the continuous wave optical input prior to formation of the optical pulses.

6. A method according to claim 4, in which the one or more analogue electrical signals are modulated onto each channel of optical pulses after formation of the pulses.

7. A method according to claim 1, in which dividing the optical power and allocating the consecutive slices comprises inputting the continuous wave optical input into an first electro-optic modulator, driving two arms of the electro-optic modulator with drive signals comprising a first pair of oscillating voltages with a phase difference of 180°, and passing the modulated optical input through a first optical combiner configured to pass alternate portions of the optical power to two output ports.

8. A method according to claim 7, in which the two output ports each output one of the channels of optical pulses, such that two channels of optical pulses are formed.

9. A method according to claim 7, further comprising inputting the output from each of the two output ports to a further electro-optic modulator, the two arms of which are driven with drive signals comprising a further pair of oscillating voltages with a phase difference of 180°, and a phase difference of 90° from the first pair of oscillating voltages, and passing the modulated output through a further optical combiner, such that the four output ports of the two further optical combiners each output one of the channels of optical pulses, so that four channels of optical pulses are formed.

10. A method according to claim 7, in which the first electro-optic modulator and the further electro-optic modulators comprises Mach-Zehnder modulators, and the first optical combiners and the further optical combiners comprise multimode interference structures.

11. A method according to claim 7, further comprising passing the optical pulses of each channel through a modulator module configured to modulate the optical power amplitude of the optical pulses to encode binary data, in which the binary data is embedded into drive signals for the modulator modules which are triggered with clock signals corresponding to the pairs of oscillating voltages used to drive the electro-optic modulators, in order to synchronise the modulation with the time and repetition rate of the optical pulses in each channel.

12. A method according to claim 11, further comprising passing the clock signals through variable delay lines to compensate for any optical propagation delay experienced by the optical pulses before arrival at the modulator modules.

13. A method according to claim 7, further comprising passing the optical pulses of each channel through a modulator module configured to modulate the optical power amplitude of the optical pulses to encode binary data, the modulator module comprising modulator arms with segmented drive electrodes, in which the binary data is embedded into drive signals for the segmented drive electrodes which have a pulse width equal to or greater than an optical propagation time for the optical pulses to propagate through the modulator arms.

14. A method according to claim 7, further comprising passing the optical pulses of at least one channel through a modulator module configured to modulate the optical power amplitude of the optical pulses to encode binary data, and passing the optical pulses of at least one other channel through a modulator module configured to modulate the optical power amplitude of the optical pulses to encode analogue data.

15. A method according to claim 11, further comprising combining the modulated optical pulses of each channel by interleaving the optical pulses in time to form a multiplexed signal.

16. A method according to claim 15, further comprising transmitting the multiplexed signal, receiving the multiplexed signal, and demultiplexing the multiplexed signal to separate the modulated optical pulses back into the channels.

17. A device for generating multiple channels of optical pulses, the device comprising:
an electro-optic modulator configured to receive an input comprising a continuous wave optical input having an optical power;
a signal generator configured to generate drive signals for the electro-optic modulator comprising a first pair of oscillating voltages with a phase difference of 180°; and
an optical combiner configured to receive the modulated optical power from the electro-optic modulator and pass alternate portions of the optical power to two output ports;
in order to divide the optical power of the optical input into equal consecutive slices in the time domain, and allocate the consecutive slices sequentially to the two output ports such that the output from each output port forms a channel of optical pulses of equal pulse repetition rate shifted in time relative to the other channel.

18. A device according to claim 17, in which the signal generator is further configured to generate a second pair of oscillating voltages with a phase difference of 180° and a phase difference of 90° from the first pair of oscillating voltages; and
the device further comprises two further electro-optic modulators each configured to receive the optical pulses output from an output port of the optical combiner and driven with the second pair of oscillating voltages; and
two further optical combiners each configured to receive the modulated optical pulses from one of the further electro-optic modulators, and pass alternate portions of the optical power to two output ports;
such that the four output ports of the two further optical combiners each output a channel of optical pulses of equal pulse repetition rate shifted in time relative to the other channels.

19. A device according to claim 17, in which the electro-optic modulator or modulators comprise Mach-Zehnder modulators, and the optical combiner or combiners comprise multimode interference structures.

20. A device according to claim 17, further comprising modulator modules each configured to receive the optical pulses of a channel and modulate the optical power amplitude of the optical pulses to encode binary data, and drive modules for each modulator module configured to generate drive signals for the corresponding modulator module in which the binary data is embedded.

21. A device according to claim 20, in which the signal generator is configured to generate clock signals corresponding to the pairs of oscillating voltages, and the drive modules are configured to be triggered with the clock signals in order to synchronise the modulation with the time and repetition rate of the optical pulses in each channel.

22. A device according to claim 21, further comprising variable delay lines for the clock signals configured to compensate for any optical propagation delay experienced by the optical pulses before arrival at the modulator modules.

23. A device according to claim 20, in which each modulator module comprises modulator arms with segmented drive electrodes, and the drive modules are configured to generate drive signals which have a pulse width equal to or greater than an optical propagation time for the optical pulses to propagate through the modulator arms.

24. A device according to claim 17, further comprising modulator modules each configured to receive the optical pulses of a channel and modulate the optical power amplitude of the optical pulses to encode data, wherein at least one modulator module is configured to encode binary data and at least one modulator module is configured to encode analogue data.

25. A device according to claim 20, further comprising one or more optical combiners to receive the modulated optical pulses of each channel and combine the pulses to form a multiplexed signal by interleaving the pulses in time.

26. A device according to claim 25, further comprising an optical routing component configured to transmit the multiplexed signal to a required destination.

27. A device according to claim 26, further comprising a demultiplexing component configured to receive the multiplexed signal from the optical routing component and separate the modulated optical pulses into the channels.

28. A device according to claim 17, further comprising:
modulator modules each configured to receive the optical pulses of a channel and modulate the optical power amplitude of the optical pulses with one or more analogue electrical signals;
photodetectors each configured to detect the power of the optical pulses in a channel and output a corresponding electrical signal; and
analogue-to-digital converters each configured to convert one of the electrical signals to a digital binary signal.

29. A device according to claim 28, in which the signal generator is configured to generate clock signals corresponding to the pairs of oscillating voltages, and the analogue-to-digital converters are configured to be triggered with the clock signals in order to synchronise the conversion with the time and repetition rate of the optical pulses in each channel.

30. A device according to claim 17, further comprising:
a modulator module configured to modulate the continuous wave optical input with an analogue electrical signal before the continuous wave optical input is received by the electro-optic modulator;
photodetectors each configured to detect the power of the optical pulses in a channel and output a corresponding electrical signal; and
analogue-to-digital converters each configured to convert one of the electrical signals to a digital binary signal.
